(19) United States
(12) Patent Application Publication
(10) Pub. No.: US 2025/0007623 A1
(43) Pub. Date: Jan. 2, 2025

(54) DATA COMMUNICATION OVER INAUDIBLE SIGNALS

(71) Applicant: inThrall Global Corporation, Corvallis, OR (US)

(72) Inventor: Harry Henry Hart, III, Corvallis, OR (US)

(73) Assignee: inThrall Global Corporation, Corvallis, OR (US)

(21) Appl. No.: 18/757,035

(22) Filed: Jun. 27, 2024

Related U.S. Application Data
(60) Provisional application No. 63/510,860, filed on Jun. 28, 2023.

(51) Int. Cl. H04B 11/00; G10L 19/002; G10L 19/018; G10L 19/02; G10L 25/18

(52) U.S. Cl. CPC H04B 11/00; G10L 19/002; G10L 19/018; G10L 19/0204; G10L 25/18

(57) ABSTRACT

Methods and systems for data transmission over inaudible signals are disclosed. The methods and systems include encoding, converting, and embedding inaudible signals into existing audio content. This allows users with receiving devices to detect and decode the inaudible signals to seamlessly access real-time interactive features, surpassing the limitations of traditional visual or tactile input.

### CROSS-REFERENCE TO RELATED APPLICATIONS

This application claims the benefit of U.S. Provisional Patent Application No. 63/510,860, filed on Jun. 28, 2023 and entitled “Data Communication Over Inaudible Signals.” The complete disclosure of the above application is hereby incorporated by reference for all purposes.

### BACKGROUND

The present disclosure pertains to the field of data communication and transmission, specifically addressing the secure and efficient transmission and communication of data over inaudible signals, such as ultrasonic tones.

Conventional data transmission methods often involve wired or wireless connections that necessitate substantial user involvement for data access and reception. These methods can be inconvenient and may require additional involvement by users. Advances in communication technology have facilitated the swift and efficient sharing of vast amounts of data through networks like the Internet, terrestrial communication systems, and satellite communication systems. However, such systems are primarily designed for high data rates and long transmission ranges, rendering them impractical and costly for short-distance transfers, such as between retailers and customers, advertisers and consumers, patients and healthcare providers, etc.

Users frequently encounter inefficiencies and frustrations when searching for information or filtering irrelevant results while consuming media or navigating physical spaces. While communication systems utilizing radio frequency (RF) or infrared (IR) signals have been developed, they often require specialized and expensive hardware. Non-wireless connections involving physical wires or cables are also burdensome and inconvenient for users.

There is a need, therefore, for streamlining the process of accessing and retrieving information to significantly improve efficiency and enhance users' experience across various contexts with available equipment and little to no involvement from the user, obviating the need for extensive searching and filtering by the users.

### SUMMARY

The disclosed methods and systems present innovative solutions designed to enhance users' engagement and interaction within their environment, surpassing the limitations of traditional interaction means that heavily rely on visual or tactile input. The present disclosure leverages inaudible signals embedded in audio channels to provide users with seamless access to a multitude of real-time interactive features.

Various embodiments of the present disclosure leverage the utilization of inaudible signals, seamlessly embedding them into audio channels to provide users with effortless access to interactive functionalities. The disclosed methods and systems demonstrate exceptional performance for short-distance transfers, facilitating efficient communication between a multitude of users such as retailers and customers, advertisers and consumers, patients and healthcare providers, and other similar interactions.

The potential applications of data communication over inaudible signals are vast and encompass numerous industries. For instance, in the healthcare sector, this technology could enable wireless communication between medical devices implanted on the human body and external monitoring systems, providing enhanced patient comfort and reducing the risk of infections associated with physical connectors.

In the retail sector, inaudible signals could be employed for location-based services, targeted advertising, and contactless payment systems, delivering seamless and personalized experiences to consumers. Industrial automation, home automation, and security systems could also benefit from discreet and efficient data transmission over inaudible signals, enabling real-time monitoring, control, and improved security.

In general, the disclosed methods and systems address inefficiencies and the need for users' input by harnessing audio, visual, and motion triggers to directly deliver relevant information and media-rich content to users, obviating the need for extensive searching and filtering. By streamlining the information retrieval process, the system significantly enhances efficiency and user experience across various contexts.

The disclosed methods and systems are designed to enable seamless interaction by embedding inaudible signals in the audio channels of diverse media, including but not limited to, public and private audio systems, public address systems, online videos, news broadcasts, movies, television programs, social media content, e.g., TikTok and Instagram, event venues, sports venues, radio commercials, greeting cards, Internet of Things (IoT) devices, point of sale registers, automobile entertainment centers, gaming consoles, music, medical equipment, and other specialized equipment. These imperceptible signals can be detected and decoded by specialized software, activating an immersive and context-aware user interface that offers a wide range of interactive options.

These interactive options include, but are not limited to, accessing device specific information and diagnostics, controlling application and device functionalities, accessing social networks, providing multimedia content, offering coupons, providing VIP offers, accessing smartphone applications, controlling application programming interface (API) activations, providing location-specific holograms, as well as providing augmented reality experiences. To ensure consistent interactivity, the system may incorporate additional capabilities such as global positioning system (GPS)-based geofencing, quick response (QR) codes, machine-readable images, and motion detection, particularly in areas where inaudible signals are not feasible.

The term “inaudible signal,” as used herein, refers to signals outside the range of human hearing or signals undetectable by humans. Generally, frequencies above 20,000 Hz or below 20 Hz, or those near these ranges, are utilized as inaudible signals. This includes not only ultrasonic tones but also tones near the ultrasonic range. For example, frequencies above 16,000 Hz or below 300 Hz are considered inaudible. More broadly, an inaudible signal encompasses any signal, waveform, frequency, or code transmitted by a source or encoding/transmitting device and detectable by a decoding/receiving device. The inaudible signal can be processed passively by a decoding device's running process or routine. Implementing inaudible signal transmission eliminates the need for complex infrastructure, providing versatile and cost-effective solutions.

In summary, the present invention revolutionizes data transmission by exploiting inaudible signals as a secure and efficient communication medium. Users can effortlessly engage with their environment, accessing a wide range of interactive features and personalized experiences through this innovative system. The seamless integration of inaudible signals and software detection provides a comprehensive solution for enhancing user interaction in diverse contexts.

The disclosed methods and systems offer a novel approach to securely and efficiently transmit data using inaudible signals by employing robust encoding and decoding techniques. The invention facilitates the conversion of data into and from inaudible signals, which are then transmitted through a suitable medium. The invention encompasses the necessary hardware and software components required for seamless data transmission and reception.

### BRIEF DESCRIPTION OF THE SEVERAL DRAWINGS

For a better understanding of the invention, and to show how the same may be carried into effect, reference will now be made, by way of example to the accompanying drawings, which:

FIG. 1 is an example of a method of transmitting inaudible signals;

FIG. 2 is an example of a method of converting a user's message or data into an inaudible signal audio track;

FIG. 3 is an illustrative example of a message being encoded according to the method of FIG. 2;

FIG. 4 is an example of a system transmitting and receiving inaudible signals;

FIG. 5 is an example of a method receiving and decoding inaudible signals;

FIG. 6 is an example of a method of decoding an inaudible signal audio track containing a user's message;

FIG. 7 is a schematic diagram of various components of an illustrative data processing system;

FIG. 8 is a schematic representation of an illustrative distributed data processing system;

FIG. 9 is a schematic representation of various components of an illustrative transmitting device;

FIG. 10 is a schematic representation of various components of an illustrative receiving device; and

FIG. 11 is a schematic representation of various components of an illustrative remote server.

### DETAILED DESCRIPTION OF PREFERRED EMBODIMENTS

Various embodiments of methods and systems of data communication over inaudible signals are configured to transmit data between two devices are described below and illustrated in the associated drawings. Unless otherwise specified, the methods and systems of data communication over inaudible signals system and/or their various components may contain at least one of the structure, components, functionality, and/or variations described, illustrated, and/or incorporated herein. Furthermore, the structures, components, functionalities, and/or variations described, illustrated, and/or incorporated herein in connection with the present disclosure may be included in other similar data transmission systems. The following description of various embodiments is merely illustrative in nature and is in no way intended to limit the disclosure, its application, or uses. Additionally, the advantages provided by the embodiments, as described below, are illustrative in nature and not all embodiments provide the same advantages or the same degree of advantages.

Aspects of methods and systems of data communication over inaudible signals may be embodied as a computer method, computer system, or computer program product. Accordingly, aspects of the methods and systems of data communication over inaudible signals may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the data communication over inaudible signals system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, IR, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a solid-state drive, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including electro-magnetic, optical, audible, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including wireless, wireline, optical fiber cable, RF, and/or the like, and/or any suitable combination of these.

Computer program code for carrying out operations for aspects of the methods and systems of data communication over inaudible signals may be written in one or any combination of programming languages, including an object-oriented programming language such as Python, Java, Smalltalk, C++, C Sharp, Swift, and/or the like, and conventional procedural programming languages, such as the C programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the methods and systems of data communication over inaudible signals are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions also can be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions also can be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the methods and systems of data communication over inaudible signals. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

The present disclosure pertains to methods and systems for communicating and transmitting data communication over inaudible signals. In certain embodiments, the inaudible signals take the form of ultrasonic tones. These tones are effectively embedded within various audio channels of different media platforms including, but not limited to, social media platforms, streaming service platforms, television, public address systems in retail stores, event venues, sports venues, radio commercials, greeting cards, IoT devices, point of sale registers, automobile entertainment centers, and gaming consoles. The generation of these ultrasonic tones can be achieved through proprietary algorithms, incorporating the methods described below, as well as any other techniques known to those skilled in the art. Concurrently, a unique code is created based on these generated signals, which can be saved in various formats such as audio files, QR codes, bar codes, or AI machine-readable images, among others.

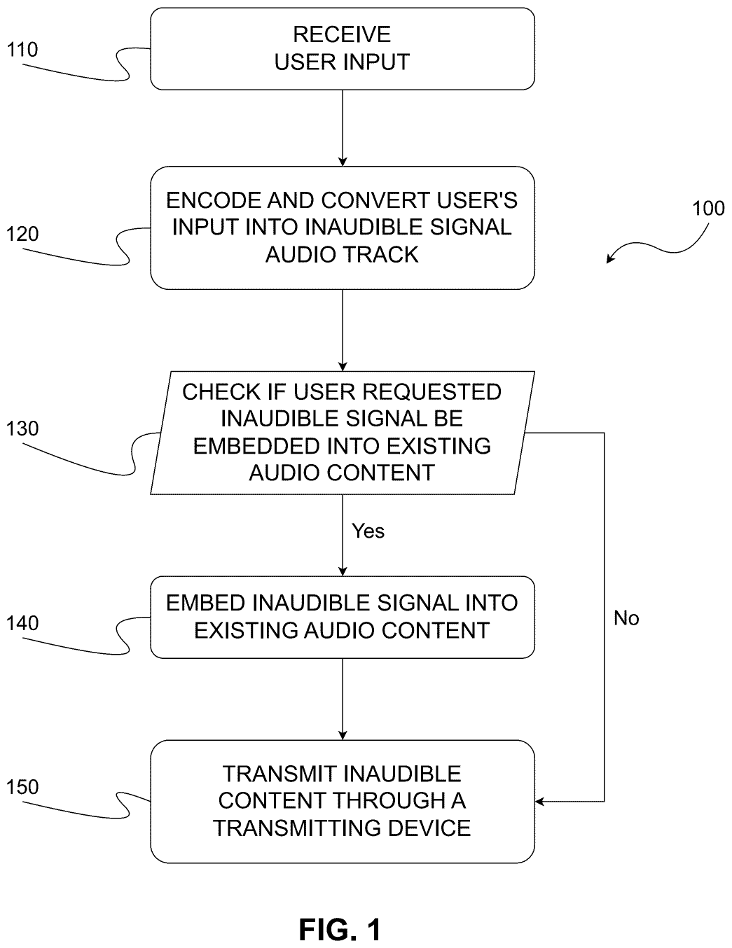

The present disclosure provides a detailed description of generating, encoding, and embedding inaudible signals into existing audio content to transmit data. FIG. 1 illustrates a method of transmitting inaudible signals. Although various steps of method 100 are described below and depicted in FIG. 1, the steps need not necessarily all be performed, and in some cases may be performed in a different order than the order shown. In this embodiment, ultrasonic tones serve as a chosen modality for data transmission, although other suitable inaudible signals may also be effectively utilized.

When a user desires to transmit data/messages over inaudible signals, the user provides the desired data to a system 100, which can be deployed on either a local transmitting device or received by a remote server. This utilization of the system 100 on a local transmitting device or a remote server enables the efficient processing and handling of the user input. During the process, at step 110, the system 100 actively checks for any user input. If an input is received at step 110, the system 100 proceeds to step 120. Otherwise, if no input is detected, the system 100 remains in a loop at step 110 until a user provides an input.

At step 120, the system 100 applies an encoding process to the data received from the user, converting it into a binary format suitable for the generation of inaudible signals. This ensures the compatibility and effectiveness of subsequent operations. Following the binary conversion, the system 100 further encodes the binary data by mapping it onto carrier frequencies to facilitate the storage and transmission of the encoded information. The system 100 then establishes a data profile encompassing encoding details. This data profile includes crucial information, such as the number of frequencies employed for message encoding. By defining a comprehensive data profile, the system enables accurate and efficient decoding of the encoded data.

Line coding is an option for converting binary data into digital signals suitable for transmission over a medium. It involves representing each bit of data with a specific pattern of signal variations to ensure reliable transmission and synchronization. Common line coding techniques include Non-Return-to-Zero (NRZ), Return-to-Zero (RZ), Manchester Encoding, and Differential Manchester Encoding. For example, Non-Return-to-Zero (NRZ) is a line coding technique where the signal remains at one level for the entire duration of the bit. Return-to-Zero (RZ) involves the signal returning to zero between each bit, which helps in maintaining synchronization. Manchester Encoding uses a transition in the middle of each bit period to represent data, with ‘0’ and ‘l’ having opposite transitions. Differential Manchester Encoding is similar but bases the transition at the beginning of each bit on the previous bit's state. These techniques ensure that the binary data is transmitted accurately and can be decoded reliably at the receiving end.

In addition, in embodiments, the system 100 may also incorporates Orthogonal Frequency-Division Multiplexing (OFDM) to further enhance the transmission efficiency and reliability of data over inaudible signals. OFDM is a method of encoding digital data on multiple carrier frequencies. OFDM efficiently divides a communication channel into multiple narrowband frequencies, known as sub-carriers, that are orthogonal to each other. This orthogonality ensures that there is minimal interference between the sub-carriers, even if they are closely spaced. Each sub-carrier is modulated with a portion of the data stream, enabling high data rates and robust communication, particularly in environments with significant multipath propagation. By leveraging OFDM, the present invention can enhance the transmission of data over inaudible signals, ensuring reliable and efficient communication even in challenging acoustic environments. This makes it particularly suitable for short-distance data transfers between devices, as it can effectively mitigate issues such as signal fading and interference.

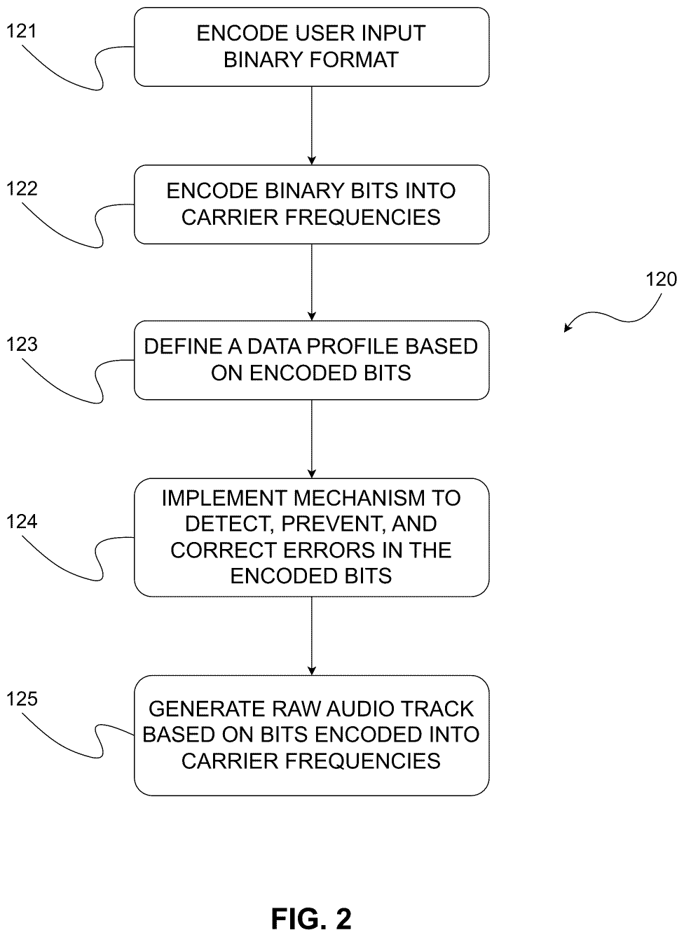

Furthermore, at step 120, the system 100 in a plurality of embodiments integrates mechanism for error detection, prevention, and correction to ensure the integrity and reliability of the encoded data. Any combination of these mechanisms works together to identify, mitigate, and rectify errors that may arise during the encoding process. This allows the system 100 to protect the reliability and data integrity of the encoded data. The system 100 then utilizes a signal generator to generate a raw audio track containing the encoded message. This process of encoding and converting the user's input into inaudible signal audio track is described in more detail with respect to FIG. 2 below.

Following the encoding of the message into inaudible signals saved into a desired suitable format, e.g., a raw audio track, the system 100 advances to step 130, where it determines whether the user has requested the embedding of the inaudible signal into existing audio content. This determination can occur at any point during the process. For instance, the user may indicate a preference for embedding the message into existing audio content as early as step 110. If the user has indeed chosen to embed the inaudible signal into existing audio content, the system 100 proceeds to step 140. Conversely, if the user has not opted for this embedding, the system 100 skips step 140 and moves directly to step 150, described in more detail below.

At step 140, the system 100 performs the task of embedding the inaudible signal into the selected existing audio content, which could be, for instance, a television program. This embedding process seamlessly integrates the inaudible signal with the audio content, ensuring that the added information remains imperceptible to human listeners. By incorporating the inaudible signal into the existing audio content, the system 100 facilitates the simultaneous transmission of both audible and embedded inaudible signals, expanding the possibilities for data transfer, content enrichment, or targeted interactions.

Embedding inaudible signals into existing audible audio involves incorporating inaudible frequencies within the audible frequency range. These inaudible frequencies are then modulated or combined with audible frequencies, which are within the human hearing range, to create a composite audio signal, using for example, a digital-to-analog converter (DAC). The composite audio signal can be generated by manipulating the amplitude, phase, or frequency of the audible frequencies to embed the inaudible signals. For example, Amplitude Shift Keying (ASK), frequency-shift keying (FSK), or phase-shift keying (PSK) techniques can be employed to encode data in the inaudible frequency range by modulating the audible carrier frequencies. Those skilled in the art will appreciate that various techniques may be employed to combine inaudible signals with audible frequencies.

Further, the inaudible signals can be combined with existing audio content using a verity of techniques, including Frequency Division Multiplexing (FDM), where the FDM is used to combine the two signals. This technique allows multiple signals to occupy different frequency bands within the same channel, avoiding interference. In embodiments, two or more frequency bands are selected in the inaudible range to carry the inaudible signals, or user input, and are multiplexed with existing audio content. The technique applies band-pass filters to isolate the frequency bands of each signal. This ensures that each signal stays within its designated frequency band. It also adds the two filtered signals together using an audio mixer or a digital signal processor.

Certain embodiments of the present disclosure take into account signal amplitude and strength, frequency distribution and background noise, temporal patterns, and duration as factors when combining inaudible signals with audible frequencies to ensure the integrity of the embedded inaudible signals. Those embodiments employ careful balancing of the inaudible components with the audible components to maintain the desired audio quality and minimize any potential audible artifacts or distortions. By considering and analyzing these characteristics, the system 100 optimizes the placement of the inaudible signals to avoid interfering with the audibility and intelligibility of the original content.

Some embodiments employ embedding algorithms to dynamically adjust the intensity and distribution of inaudible signals, adapting to the specific characteristics of the existing audio content to achieve optimal placement of the inaudible signals. These algorithms preserve the spectral balance, dynamic range, and overall quality of the original/existing audio content, guaranteeing a seamless listening experience for the intended recipients.

By embedding inaudible signals within existing audio content, the system 100 enhances communication capabilities utilizing the vast array of available audio content. This approach allows for flexible transmission of messages through widely accessible platforms, such as music streaming services, radio broadcasts, or even public address systems. Leveraging the ubiquity of audio content, the system 100 opens up new avenues for data transmission without compromising the existing audio content or the user's listening experience. At the end of step 140, the encoded message at step 130, containing the inaudible signals in a suitable format, is combined with an original/existing audio content to create a composite audio track.

At step 150, when the composite audio track is prepared for transmission, the system 100 proceeds to transmit the inaudible signal containing the user's message/data to a transmitting device capable of emitting inaudible signals. Such transmitting devices can include public address systems, televisions, mobile devices, cars, or any sound-emitting device. The specific choice of the transmitting device may vary depending on the implementation and intended use case. The composite audio track, containing the embedded inaudible signals, is delivered to the transmitting device through various transmission methods, such as wired or wireless connections. This enables the utilization of existing audio infrastructure, facilitating seamless dissemination of the inaudible signals. Throughout the transmission process, the integrity of the inaudible signals is preserved, ensuring that a receiving device can accurately decode and extract the embedded information.

In some embodiments, the system 100 may be incorporated directly within a transmitting device. For example, a mobile device can integrate the system 100, allowing it to receive a user input, encode and convert that input into inaudible signal audio track, embed the inaudible signal audio track into existing audio content based on the user's request creating a composite audio track, and transmit the composite audio track from within, i.e., directly from its speakers. Once the composite audio track is played on the mobile device, it becomes ready for reception, and the inaudible signals embedded within it are prepared for decoding.

A practical example illustrating the innovative nature of the present disclosure involves the implementation of the system 100. Let us consider a scenario where a retailer intends to promote its products using the system 100, with a specific target audience or end users in mind. In step 110, the retailer submits the content of its advertisement to the system 100. It should be noted that the content described here can take the form of any message intended for transmission. The example provided, using “advertisement” as the content, is purely for illustrative purposes. This content can take various forms, such as a URL to the retailer's products, a coupon code, a VIP offer, social media content, etc. The system 100 takes charge of managing and encoding this content, converting it into ultrasonic tones that represent the retailer's message. These tones can be shared directly with end users through different channels, such as public speakers or by embedding them into other audio content.

In most cases, the retailer would prefer to embed its advertisements within other forms of content to specifically target a desired audience or end users. Let us imagine the retailer is a car manufacturer that has collaborated with a movie production, ensuring that only its vehicles are featured in the movie. To effectively reach their intended audience, the retailer would choose to embed their advertisement within the movie, as depicted in step 130. This approach allows the retailer to precisely target the viewers of a particular movie without compromising their viewing experience. The embedding process itself is facilitated by step 140.

Once the advertisement is seamlessly integrated into the movie, it can be transmitted to the audience or end users in step 150 using various mediums, such as movie theatre speakers or television speakers. Consequently, the audience or end users can conveniently receive and access the advertisement through their mobile devices, wearable devices, or any preferred device without any disruption to the movie or any alteration to its original quality.

To further illustrate the inventive nature of the present disclosure, let us explore another example that demonstrates the application of the system 100. Imagine a scenario where a sporting team aims to promote its brand and merchandise to attendees during a live game. The team can utilize the system 100 to effectively broadcast its message through the existing audio systems present in its venue. In step 110, the team provides the content of its advertisement to the system 100, which can include location of its points of sale, ordering forms, promotional URLs, exclusive offers, merchandise details, or social media content related to the team. The system 100 takes charge of managing and encoding this content, converting it into ultrasonic tones that represent the team's marketing message.

In this particular case, the team would prefer to leverage the existing audio infrastructure within the venue to reach its target audience—the game attendees. By embedding their advertisements within the audio broadcast, recorded music, or other announcements the team can effectively promote its merchandise without causing any disruption to the event experience. For instance, during breaks or intervals in the event, step 130 involves seamlessly integrating the team's advertisements into the audio content being played through the venue's speakers. This enables the team to specifically target the attendees without compromising the overall event atmosphere. The embedding process is made possible through step 140, which ensures a seamless integration of the team's advertisements into the audio system.

Once the advertisements are successfully embedded into the venue's audio system, recorded or live broadcast, or other audio content, the advertisements can be transmitted to the event attendees in step 150. The attendees can receive and access the team's promotional content through their mobile devices, wearable devices, or any preferred device without any interference with the event or the audio quality. The team's message can effectively reach the attendees, promoting their brand, merchandise, and encouraging further engagement with their fan base. By utilizing the system 100 in this manner, the sporting team can enhance their marketing efforts and capitalize on the existing infrastructure within the event venue to maximize their reach and impact.

Another compelling example showcasing the ingenuity of the present disclosure involves the use of the system 100 in a concert setting, where an artist desires to provide concertgoers with enhanced experiences and interactive elements during their performance. Let us imagine a scenario where a renowned musician wants to engage the audience by granting them access to the lyrics of a new song or triggering their mobile devices' flashlights automatically. Through the utilization of the system 100, the artist can seamlessly integrate these features into the concert environment and the venue's existing audio system.

In step 110, the artist provides the necessary content to the system, such as the lyrics to the new song and/or instructions to activate the mobile devices' flashlights. The system 100 then manages and encodes this content, transforming it into ultrasonic tones that represent the desired instructions and information.

During the concert, at appropriate moments in the performance, the artist can embed the encoded content within the audio output, effectively synchronizing it with the music. This embedding process, depicted in step 130, allows the artist to dynamically provide the lyrics to the audience members' devices or trigger the flashlights of their mobile devices in unison. The integration is seamless and harmonizes with the overall concert experience, enhancing the audience's connection with the artist and the music. This embedding capability is made possible through step 140, which ensures the smooth integration of the artist's instructions and content into the audio system of the concert venue.

As a result, in step 150, concertgoers are able to receive and access the interactive features on their mobile devices without disrupting the concert or compromising its audio quality. They can follow along with the lyrics of the new song, immersing themselves in the artist's performance, or activate their mobile devices' flashlights to create a visually captivating atmosphere. By utilizing the system 100, the artist can engage and captivate the audience on a whole new level, fostering a memorable and interactive concert experience that leaves a lasting impression.

The three examples presented above vividly demonstrate the limitless beneficial applications of the system 100. Whether it is enabling retailers to reach targeted audiences seamlessly, empowering sporting teams to promote merchandise during live events without disruption, or enhancing concert experiences through interactive features, the system 100 proves its versatility and effectiveness. These examples highlight how the system can revolutionize advertising, marketing, and audience engagement across various industries. With its ability to manage and encode content into ultrasonic tones, seamlessly embed it into existing audio systems, and ensure a smooth user experience, the system 100 opens the door to endless possibilities for innovative and impactful implementations.

By way of example, if a user enters the message “Hello” into the system to be combined with an existing. The process begins by performing a frequency analysis of the existing audio signal using tools like a spectrum analyzer or Fast Fourier Transform (FFT). For instance, if the existing audio signal occupies frequencies between 300 Hz and 16 kHz, it selects a different frequency band for the text signal, such as 16 kHz to 24 kHz, to avoid overlap. Then, it converts the text message “Hello” into binary format using ASCII or UTF-8 encoding and then modulates this binary data using Frequency Shift Keying (FSK), or any suitable technique, within the 16 kHz to 24 kHz band.

Next, it applies band-pass filters to both the existing and text signals to isolate their respective frequency bands. It then sums the filtered signals using an audio mixer or digital signal processor to create a combined audio signal. This combined signal is then amplified, filtered, and transmitted over the chosen medium.

Upon reception, the combined audio signal is separated into its original components using band-pass filters. The existing audio signal is filtered out from the 300 Hz to 16k kHz band, while the text signal is filtered out from the 16 kHz to 24 kHz band. The text signal is then demodulated to retrieve the binary data, which is subsequently converted back into text using the same encoding scheme used during modulation. This workflow ensures that the text-encoded audio signal can coexist with the existing audio signal in a different frequency band without interference.

FIG. 2 is an example of a method of converting a user's message or data into an inaudible signal audio track. This method demonstrates the process of encoding and converting a user's message or data into an inaudible signal audio track. This depiction serves as a detailed flowchart that expands on the details of step 120 as shown in FIG. 1. Although various steps of method 120 are described below and depicted in FIG. 2, the steps need not necessarily all be performed, and in some cases may be performed in a different order than the order shown. The flowchart provides a comprehensive breakdown of the various steps involved, building upon the foundation laid out in FIG. 1, particularly step 120.

At this step 121, and in the case of ultrasonic tones, each message is converted into a bit array, incorporating the information contained in the message. This conversion can occur using techniques such as ASCII or UTF-8 encoding. Once the user's data has been converted into bits, each bit is encoded as an acoustic signal into one of a plurality of carrier frequencies at step 122. An illustrative embodiment of this encoding technique is described in detail below.

Next, step 122 encodes binary bits, encompassing the user's message, into carrier frequencies. Messages are structured in two dimensions: temporal and spectral, where frequency is the spectral dimension. Along the temporal dimension, a message consists of consecutive blocks. The message starts with a “start block,” followed by “message blocks” (M), and concludes with an “end block.” Each message block has a duration (D) of D milliseconds, while the start and end blocks have a duration of D/2 milliseconds. Multiple carrier frequencies (Fi) span each block, with Fi in the set {F1, F2, . . . , FC} being equally spaced and covering a frequency band (B) of B=FC−F1 Hz. The frequency spacing(S) is S=B/(C−1) Hz. By addressing a block number and carrier frequency, each bit in a message can be encoded into a carrier frequency and the massage can be transmitted in parallel on multiple carrier frequencies. In embodiments, the frequency band is 16 kHz to 24 kHz and the frequency spacing is 1 kHz. In further embodiment, two frequency bands are selected.

As explained above, data is encoded in a binary format at step 121. Each message block encodes one bit at each carrier frequency Fi at step 122. A logical “1” is represented by a non-zero/“high” amplitude during the first D/2 milliseconds at frequency Fi, followed by an approximately zero amplitude during the second D/2 milliseconds. Conversely, a logical “0” is encoded with an approximately zero amplitude during the first D/2 milliseconds at carrier frequency Fi, and a non-zero/“high” amplitude during the second D/2 milliseconds. The amplitude of the zero and non-zero/“high” signal may vary depending on the specific use case, hardware employed, and desired transmission range.

The binary message content can be sequentially encoded across the carrier frequencies, starting from the lowest frequency (F1) to the highest frequency (FC). For instance, the first bit is encoded at message block 1 and carrier frequency F1, the second bit at message block 2 and carrier frequency F2, and so on. Additionally, pauses (P) can be inserted between message blocks and within each block, such as after a specified time period or for illustrative purposes after the first D/2 milliseconds of a message block. The duration of the pause can be greater than or equal to zero, and the sending amplitude during the pause is set to approximately zero. Consequently, the overall message duration becomes: D/2+P+D*M+P*(2*M−1)+P+D/2=D*(M+1)+P*(2*M+1) milliseconds.

The first and last blocks of a message correspond to the start and end blocks, respectively. In certain embodiments, the start block is encoded with a non-zero/“high” amplitude at the higher C/2 frequencies and an approximately zero amplitude at the remaining frequencies. Conversely, for the end block, a non-zero/“high” amplitude is present at the lower C/2 carrier frequencies and an approximately zero amplitude at the remaining frequencies. As a result, the number of bits that can be represented by a message is M*C. The maximum theoretical data rate can be calculated as: 1000/(D*(M+1)+P*(2*M+1))*(M*C) bits per second.

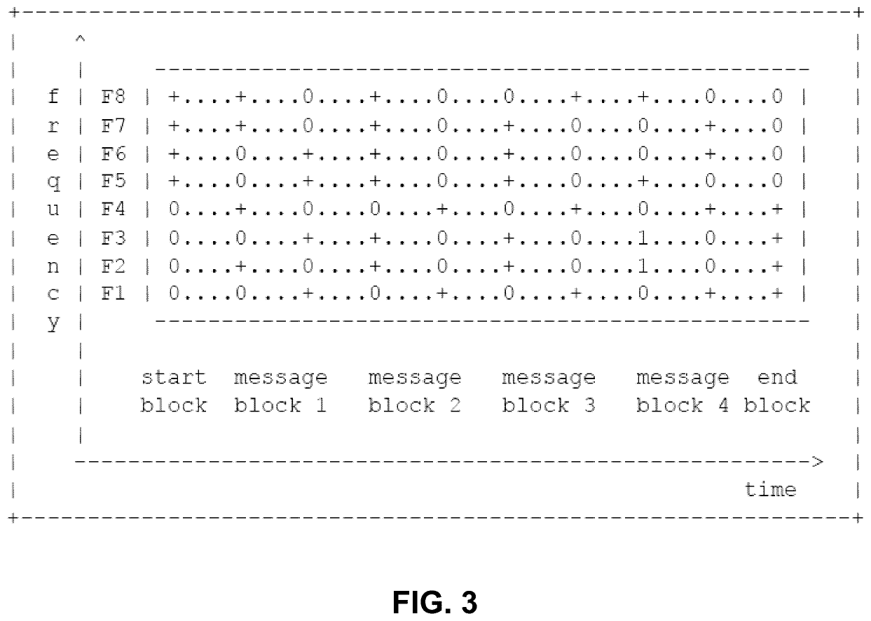

FIG. 3 illustrates an example of message encoding according to one embodiment of the invention. The graphical representation encompasses two dimensions, with the spectral dimension on the x-axis and the temporal dimension on the y-axis. The provided graph demonstrates the encoding of a binary message, “01010011 01101111 01101110 01101001,” consisting of four blocks (M=4). The encoding utilizes eight carrier frequencies (C=8), with a duration of two (D=2), and a pause duration of four (P=4). The symbol “+” denotes a non-zero/“high” amplitude, while “0” represents an approximately zero amplitude. Pause periods are indicated by the ellipsis pattern “ . . . ”

The first eight bits of the message are encoded in the first half of message block 1, from low to high frequency, while the second half of message block 1 represents the inverted information. The following eight bits are encoded in the first half of message block 2, again from low to high frequency, and so on.

At step 123, in some embodiments, a data profile is defined, encompassing information including, but not limited to, the number of message blocks, duration of each message block, pause period between message blocks, number of frequencies for message encoding, spacing between successive frequencies, and lowest frequency used. This data profile is stored on the system 100 for every encoded message to allow for efficient detection and accurate decoding by a receiving device. In some embodiments, the data profile along with other encoding information is stored using a store procedure into a log table for later retrieval during the decoding process. Those skilled in the art will appreciate that different profiles or configurations can be established to adapt to specific use cases.

A plurality of embodiments integrates mechanism for error detection, prevention, and correction to ensure the integrity and reliability of the encoded data at step 124. Preferred embodiments incorporate the splitting of the multiple frequencies carrying the message blocks into parity bits (E) for error detection and correction. Consequently, the number of bits is adjusted to accommodate the parity bits in the message payload. The size of the parity information is not standardized and depends on factors such as the use/application's environmental conditions. Other embodiments may require the use of a fixed message length, in which case any remaining bits beyond the actual information to be sent can be filled with a special symbol.

Furthermore, additional embodiments introduce redundancy as a countermeasure to ensure robust signal transmission and combat data corruption caused by environmental noise. Redundancy is generated through, for example, phase encoding, where each data bit is encoded as either low then high or high then low for an equal amount of time. This, in some embodiments, involves incorporating temporally varying characteristics of a channel, which can increase the likelihood of message corruption over longer transmission timespans. The disclosed methods and systems mitigate these sources of error by introducing redundancy in the encoding process. In some embodiments, to minimize message duration and maximize data rate, information is transmitted simultaneously through multiple channels and/or carrier frequencies in parallel. Thus, redundancy not only enhances the code's robustness but also simplifies message decoding.

To ensure the integrity of the transmitted data, preferred embodiments employ error detection techniques such as cyclic redundancy check (CRC) codes or error correcting codes during the encoding process. By implementing these mechanisms, the system 100 can identify and potentially correct any errors that may occur prior to or during the transmission of the encoded message. Additionally, for enhanced security, some embodiments encrypt the binary message using symmetric or asymmetric encryption schemes. In such cases, the exchange of encryption keys should be conducted through a separate out-of-band channel, such as Bluetooth®, to establish confidentiality and prevent unauthorized access to the transmitted information. It should be noted that peer entity authentication is not implemented at the physical layer and should be provided at a higher layer of the communication stack to ensure the identification and verification of communicating parties.

Once the user's message has been encoded into carrier frequencies, step 125 commences and the system 100 generates an inaudible signal incorporating the information contained in the user's message/data using a signal generator. This results in the production of an inaudible signal, which can be of any suitable format, such as an audio file or any other appropriate format.

Step 125 incorporates a signal generator, which is responsible for obtaining raw audio data. This raw audio data is processed to form an array of data, organizing the data in a suitable manner for subsequent creation of an inaudible signal audio track and transmission. To achieve this, the array of data undergoes an encoding process, utilizing a configuration specified in a constructor. This configuration may include parameters such as a sample rate, ensuring compatibility and optimized encoding. While various sample rates can be utilized effectively, preferred embodiments rely on a constructor using a 44100 Hz sample rate to ensure compatibility with a wide range of devices.

Generally, the signal generator system handles the creation of inaudible signals containing the encoded user messages/data. In various embodiments, the signal generator incorporates a frequency indexing mechanism. This indexing mechanism organizes the frequencies used in the inaudible signals, allowing for optimized signal processing and improved overall transmission quality. By efficiently managing the frequencies, the signal generator achieves enhanced inaudible signal reliability and reduces potential distortions or artifacts that may arise during the encoding process.

In other embodiments, the signal generator employs a fast Fourier transform (FFT) algorithm. The FFT algorithm is utilized to transform the encoded message from the time domain to the frequency domain, facilitating more efficient signal manipulation and processing. This transformation enables advanced techniques, such as spectral analysis and equalization, to be applied to the inaudible signals.

In yet further embodiments, the signal generator incorporates a normalization mechanism of inaudible signals. Inaudible signals, while typically fall outside the range of human hearing, may still affect the overall audio perception, and introduce unwanted noise. By normalizing these signals, the signal generator effectively attenuates any potential disturbances. Moreover, the signal generator, in certain embodiments, employs a fading technique for inaudible signals. By gradually fading in or out these signals, the signal generator effectively minimizes any abrupt transitions that could cause audible artifacts or disruptive noise.

In order to ensure compatibility with various playback systems and devices, some embodiments include a signal generator that incorporates a signal casting process. This process allows the inaudible signals, after undergoing the any combination of the aforementioned indexing, transformation, and normalization, to be casted into a desired suitable format, e.g., specific audio file. By adapting the inaudible signals to a specific format, such as a common audio file format, the signal generator achieves broad compatibility and facilitates easy integration with existing audio playback systems.

By employing the above-mentioned methods and systems utilizing a signal generator and array manipulation, the techniques enable the seamless integration of messages into inaudible signals, facilitating communication through audio channels. At the end of step 125, the encoded message, now represented as inaudible signals saved into a desired suitable format, is then ready to either be embedded into an existing audio content or transmitted in accordance with the methods and systems disclosed with reference to FIG. 1.

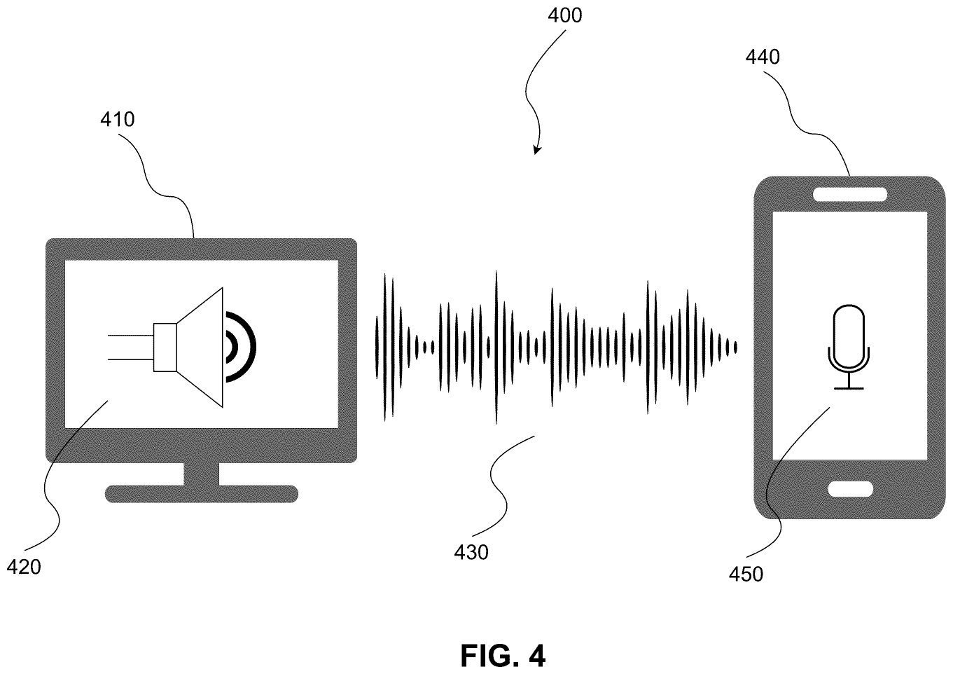

FIG. 4 is an example of a system transmitting and receiving inaudible signals. It highlights the interplay between a transmitting device and a receiving device. Upon emission into an environment 400 from the transmitting device 410, the inaudible signals propagate omnidirectionally through the air, exhibiting reflective properties. Consequently, any audio source or speaker in proximity to the receiving device 440 can serve as a source for the inaudible signals. The transmitting device 410, as described previously in reference to FIG. 1, may be a standalone device incorporating the disclosed systems and methods or a device that simply receives a composite audio track including inaudible signals containing an encoded message based on a user's input. It is important to note that the transmitting device 410 can be any device incorporating an audio emitting component 420 capable of emitting audio, such as a speaker.

The transmitting device 410 emits audio content 430 into the environment 400 via the audio emitting component 420. This audio content 430 propagates omnidirectionally and encompasses the inaudible signals, whether they are embedded within existing audio content or stand alone. Once released into the air, any receiving device 440 within the vicinity or environment 400 of the audio emitting component 420 may capture the inaudible signals. It should be noted that the receiving device 440 can be any device equipped with an audio receiving component 450, such as a microphone.

By utilizing this architecture, the disclosed system enables the seamless transmission and communication of data over inaudible signals, utilizing existing audio infrastructure and devices. The omnidirectional propagation of inaudible signals and their reception by a wide range of receiving devices enhance the versatility and accessibility of the system, facilitating efficient communication and information transfer in various environments.

In some embodiments, the transmitting device 410 incorporates a built-in capability to store a pre-existing library of inaudible signals, specifically designed for broadcasting purposes. In other embodiments, the transmitting device 410 is configured to access a remote server that hosts a comprehensive library of inaudible signals, also intended for broadcasting purposes. Additionally, in accordance with the disclosed methods and systems, further embodiments empower the transmitting device 410 to generate inaudible signals using a signal generator as detailed above.

The relationship between the transmitting device 410 and the receiving device 440 demonstrates the diverse array of forms these devices can encompass. For instance, transmitting device 410 can take the form of televisions, mobile computing devices, computers, both private and public address systems, audio systems deployed in concerts or sporting events, and even audio systems integrated into automobiles and vehicles, etc. Similarly, receiving devices 440 can be any devices equipped with the ability to detect audio signals, such as mobile computing devices, wearable computing devices, computers, smart speakers, IoT devices, voice assistants, voice-activated devices, televisions, and more.

By incorporating the aforementioned features and capabilities, the disclosed methods and systems achieve a versatile and widespread applicability, enabling seamless transmission and reception of inaudible signals across a diverse range of devices and contexts. This provides enhanced flexibility and accessibility for the effective dissemination of information encoded within the inaudible signals.

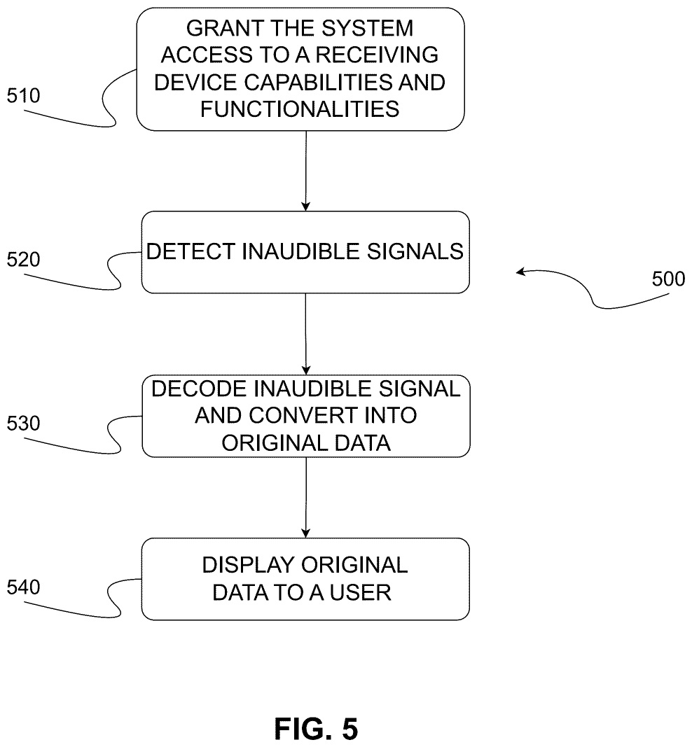

FIG. 5 is an example of a method receiving and decoding inaudible signals. Although various steps of method 500 are described below and depicted in FIG. 5, the steps need not necessarily all be performed, and in some cases may be performed in a different order than the order shown. The methods and systems disclosed with respect to FIG. 5 include methods and systems for detecting, decoding, and displaying contents of messages or data received through inaudible signals using a receiving device 510.

At step 510, a receiving device, equipped with an audio receiving component, grants the system 500 access to its capabilities and functionalities. This allows for detection of inaudible signals at step 520. It should be noted that the receiving device can be any device equipped with the ability to detect audio signals, such a wearable computing device, computers, a smart speaker, an IoT device, a voice assistant device, a voice-activated device, a television, and more.

In some embodiments, central to the receiving device is a decoder designed to proficiently decode messages transmitted through both independent inaudible signals, as well as inaudible signals seamlessly embedded within existing audio content. Once transmitted, these inaudible signals can be effortlessly received and decoded by the receiving device, drawing upon any transmitting device, e.g., audio speaker located in close proximity to the receiving device. In other embodiments, the receiving device communicates the inaudible signals to a remote server for decoding and extracting of the message, (e.g., ASCII or UTF-8 decoding), which are then relayed back to the receiving device.

To unlock the system's 500 full potential, users have the option at step 510 of granting the system 500 authorization, enabling it to access various capabilities of the receiving device, including, but not limited to, location tracking, microphone usage, camera functionality, lighting/flash functionality, accelerometer data, and device controls. These systems and methods operate seamlessly in the background, functioning continuously until the user terminates the authorization.

At step 520, after a receiving device user grants the system 500 access to its capabilities and functionalities, including its audio receiving component, the system 500 actively and continuously “listens” for inaudible signals. This is done by relying on a circular array data structure. A circular array refers to a data structure that efficiently stores incoming audio data in a continuous loop, allowing for seamless and continuous processing of detected sound data/samples.

When audio is captured by a microphone, it is typically recorded in chunks or frames of a fixed length. These frames are then stored in a buffer for further analysis or processing. A circular array, also known as a circular buffer or ring buffer, is a specific type of data structure that facilitates the efficient handling of such sequential data.

Unlike a traditional linear buffer that has a fixed size and can become full, a circular array wraps around itself, creating a circular pattern. It consists of a fixed-size array and two pointers: a read pointer and a write pointer. As new audio data is captured, it is written to the buffer at the current position indicated by the write pointer. When the buffer reaches its maximum capacity, the write pointer wraps around to the beginning of the array and continues writing the new data, effectively overwriting the oldest data.

On the other hand, the read pointer determines the position from which the audio data is retrieved for analysis or processing. As data is analyzed, the read pointer moves forward through the buffer. Once it reaches the end of the buffer, it wraps around to the beginning and continues reading the data.

Before overwriting any of the audio data received, the system 500 analyzes the data to determine whether an inaudible signal has been received. To identify inaudible signals, the system 500 extracts specific features from the audio data and compares those to data profiles defined during the encoding process. These characteristics may include information such as the base frequencies utilized, bit period(s), the number of message blocks, duration of each message block, pause period between message blocks, number of frequencies for message encoding, spacing between successive frequencies, and lowest frequency used. Other embodiments rely on predefined ranges within the encoding process to detect inaudible signals. Some embodiments utilize techniques for feature extraction include Fourier transforms, wavelet transforms, or time-frequency analysis methods. Those skilled in the art will appreciate that different methods can be used to detect the existence of inaudible signals within audio data.

Further embodiments compare the specific features extracted from the audio data received with the data profiles created during encoding that represents the expected characteristics of the inaudible signals. This profile could be based on known patterns or statistical properties of the inaudible signal. It serves as a reference against which incoming data will be compared. Using the data profiled as a reference, the system 500 compares the extracted features of the incoming data to determine if there is a match. Various matching algorithms, such as correlation or pattern recognition techniques, can be employed to identify similarities between the data profile and the analyzed samples. If a match is found above a certain threshold, it indicates the presence of the desired inaudible signal. Those skilled in the art will appreciate that different methods can be used to detect the existence of inaudible signals within audio data.

Some embodiments utilize an inbound API to facilitates the conversion of detected inaudible signals into alphanumeric equivalents and transmits those from the receiving device to an API endpoint. At the endpoint, the detected inaudible signals are captured and processed using a service broker, e.g., SQL Server Service Broker, and a stored procedure that is specifically designed to handle the insertion of log data into a log table. This procedure verifies the validity of the inaudible signals. If the inaudible signal is invalid, the stored procedure returns an “invalid” response to the receiving device, which subsequently communicates an error message to the user. On the other hand, if the code is valid, the store procedure validates the presence of content to be sent back to the receiving device.

Some embodiments perform additional post-processing steps to refine the detection results. This may involve validating the detection through statistical analysis, applying decision rules, or considering temporal context to ensure accurate and reliable detection of inaudible signals.

The system 500 employing this circular nature of the array allows for continuous recording and processing of audio data without the need to allocate additional memory or perform expensive data shifting operations. It provides a simple and efficient way to handle streaming data, such as real-time audio signals, where a continuous flow of samples needs to be analyzed or processed in a loop. By using a circular array in the context of microphone-based sound analysis, the system 500 can effectively store and manipulate audio data, ensuring a seamless and uninterrupted flow of sound samples for various processing tasks, such as decoding, amplification, filtering, or feature extraction. Various processing techniques can be used utilizing Digital Signal Processing (DSP) software, spectrum analyzers, and/or modulation/demodulation software.

Upon receiving and detecting an inaudible signal, step 530 commences and decodes inaudible signal converting them to their original form. The decoder promptly extracts vital metadata associated with the transmission, encompassing essential details like timestamps and source information. Additionally, the decoder accurately determines the data rate by considering the duration of the transmission and the volume of data involved. This meticulous data rate calculation ensures efficient transmission and optimizes future decoding and subsequent operations. Some embodiments transform inaudible signals received from and to a Unicode Transformation Format 8-bit (UTF-8) to prepare data to be displayed to the user at step 540.

In certain embodiments, the decoder effectively eliminates filling characters and CRC-bits that were introduced during the encoding process. This restoration of the original data state is achieved by converting a string of bits into a corresponding byte array, facilitating further processing or transmission of the binary data. Consequently, the decoder eradicates any lingering filling characters and error correction bits, guaranteeing a clean and unaltered message suitable for subsequent analysis and processing.

To ensure data integrity, the decoder undergoes a series of rigorous verification steps. Various embodiments incorporate thorough checks on the message length, guarding against potential issues arising from excessively long messages. Other embodiments employ iterative processes to examine each element of the data array and calculate a checksum for validation purposes. Yet further embodiments rely on error correction algorithms that actively rectify any errors detected within the transmitted data or signal. This comprehensive approach significantly enhances the reliability and accuracy of the data exchange process.

With respect to both steps 520 and 530, the receiving device during operation detects and decodes inaudible signals, automatically identifying messages or signals that satisfy specific criteria established during the encoding process or by the system 500. These criteria encompass parameters including, but are not limited to, bit periods, pause durations, frequency spacing, message length, the number of frequencies employed, and/or volume. Consequently, various combinations of these settings can effectively encode and decode messages using a proprietary algorithm, providing access to different frequency ranges. More broadly, the decoder decodes using methods comparable to the encoding process. Those skilled in the art will appreciate that different decoding methods can be employed to decode a message from an inaudible signal.

Once a signal is detected and decoded, step 540 presents its content to a user through a user interface. The user interface on the receiving device is dynamic, intelligently tailored to the user's unique profile, demographics, psychographics, usage history, and prevailing context. This immersive interface offers an array of interactive options, including, but not limited to, holograms, augmented reality experiences, social network links, multimedia content, coupons, VIP offers, smartphone applications, and API activations.

To accomplish this, the receiving device establishes secure communication with a backend system, ensuring a seamless connection. Upon detecting and decoding an inaudible signal, the backend system diligently validates its authenticity and promptly generates personalized content. This content is then transmitted as human-readable text, enabling the receiving device to provide an immersive, real-time, and context-aware user interface, perfectly aligned with the user's preferences and requirements. Those skilled in the art will appreciate that different methods can be utilized to display decoded data to a user.

In some embodiments, the system 500 analyzes a user's preexisting profile, considering demographic and psychographic information to generate tailored content to that specific user. Based on this analysis, the system 500 assembles requested content to be delivered to the receiving device 500 in any suitable form, e.g., a .JSON file. This file consists of any data relevant to the specific user's profile and may include a verity of files of different types, e.g., thumbnail images. Once the receiving device receives a .JSON package, the system 500 displays the content on an interactive user interface.

While the use of inaudible signals is one method of triggering the API, alternative activation methods are also available, including, but not limited to, being present at specific locations/location based, scanning augmented reality (AR) codes, QR codes, barcodes, AI-generated images, URLs, and more.

A practical example illustrating the innovative nature of the present disclosure involves the implementation of the system 500. Let us consider a scenario where a consumer or an end user enters into a store to purchase certain products. Assume further that the retailer is using the disclosed invention in accordance with one of the various embodiments above.

In step 510, the consumer grants the system 500 access to capabilities and functionalities of its mobile device or wearable device and thus allowing the system to detect ultrasonic tones in step 520. Because the retailer has embedded content using one of the illustrated embodiments above, the system 500 at step 520 will detect the owners message. The content of this message can take various forms, such as current offers, a coupon code, a VIP offer, new products, or even user-specific, targeted, and tailored advertisements.

The system 500 takes charge of managing and decoding this content, converting it into its original or intended form at step 530. This content is received directly by the consumer through different channels, such as through the retailer's preexisting audio system in its stores. Once the content of the message is decoded into its original or intended form, it is then displayed to the consumer on its mobile device screen or wearable device screen in accordance with step 540. Consequently, the consumers end users can conveniently receive and access content, tailored to it based on its profile search history, or other data contained within the system 500, through its mobile devices, wearable devices, personal computer, television, any device with the ability to display content, or any preferred device without any disruption to other consumer.

An exemplary embodiment, highlighting the inventive nature of the present disclosure, involves the utilization of the system 500. Let us envision a practical scenario where a consumer or end user enters a store to make a purchase, and the retailer implements the disclosed invention in accordance with one of the various embodiments described above.

In step 510, the consumer grants the system 500 access to the capabilities and functionalities of its mobile or wearable device, for instance, enabling the system 500 to detect ultrasonic tones in step 520. Leveraging the embedded content employed by the retailer, as showcased in the preceding embodiments, the system 500 efficiently captures the intended message of the content. The message itself encompasses a diverse range of possibilities, such as current offers, coupon codes, VIP promotions, new product announcements, and personalized, targeted advertisements tailored to the individual consumer.

Taking charge of managing and decoding this content, the system 500 effectively converts it back into its original or intended form in step 530. The consumer receives this content directly through various channels, including the retailer's existing audio system within their stores. Once the message's content is decoded and restored to its original format, it is presented to the consumer on their mobile device screen or wearable device screen, following the directives outlined in step 540. As a result, consumers and end users can seamlessly access tailored content based on their profile, search history, or other data within the system 500 through their preferred devices, without causing any disruption to other consumers' experiences.

This embodiment of the system 500 showcases its ingenuity and versatility, providing an enhanced and personalized shopping experience for consumers while offering retailers a powerful tool to deliver targeted messages and promotions.

Another illustrative embodiment, highlighting the innovative capabilities of the present disclosure, involves the utilization of the system 500 in the context of a rideshare service. Let us consider a scenario where a rideshare rider, utilizing the services of a rideshare company, experiences enhanced interactions through the embedded ultrasonic tones within the driver's vehicle. Upon the driver's approach to the rider's location, for instance, in preparation for pick-up, the rider's device, such as a smartphone, has the capability to initiate specific functionalities. These functionalities are granted to the system 500 at step 510 and may encompass activating the flashlight or adjusting the screen brightness to its maximum setting, displaying a distinctive color, thereby ensuring a noticeable visual cue for the driver.

In this embodiment, the system 500 has been previously granted access to the capabilities and functionalities of the rider's mobile device or wearable device, as depicted in step 510. This enables the system 500 to detect the ultrasonic tones embedded within the driver's car when they come within proximity to the rider, as described in step 520. The embedded content takes the form of specific instructions to trigger actions on the rider's device, such as activating the flashlight or adjusting the screen brightness.

Taking charge of managing and decoding this embedded content, the system 500 converts the ultrasonic tones back into their original or intended form, as shown in step 530. Once the content is decoded, the rider's device promptly responds by executing the specified actions. For instance, the device may automatically turn on the flashlight, illuminating the surrounding area, or adjust the screen brightness to its maximum setting, with a predefined color to capture the rider's attention.

This embodiment of the system 500 allows for seamless and personalized interactions between the rideshare rider and the driver's vehicle, enhancing the overall user experience. By leveraging the power of embedded ultrasonic tones and the rider's device capabilities, the system enables riders to receive specific visual cues and instructions tailored to their rideshare journey, ensuring a convenient and engaging transportation experience.

The examples presented above vividly demonstrate the boundless beneficial applications of the system 500. These illustrations serve to exemplify the system's 500 versatility and effectiveness, providing enhanced experiences in various contexts. However, it is important to note that these examples are merely for illustrative purposes and do not intend to limit the scope of the invention in any way. With its ability to manage and decode ultrasonic tones, seamlessly integrate with devices, and deliver personalized functionalities, the system 500 opens the door to countless possibilities for innovative implementations. Whether it is enabling tailored content delivery for consumers or enhancing interactions in rideshare services, the system 500 showcases its potential to revolutionize user experiences across diverse industries. It is evident that the system 500 holds immense value and holds promise for endless beneficial uses beyond the examples discussed herein.

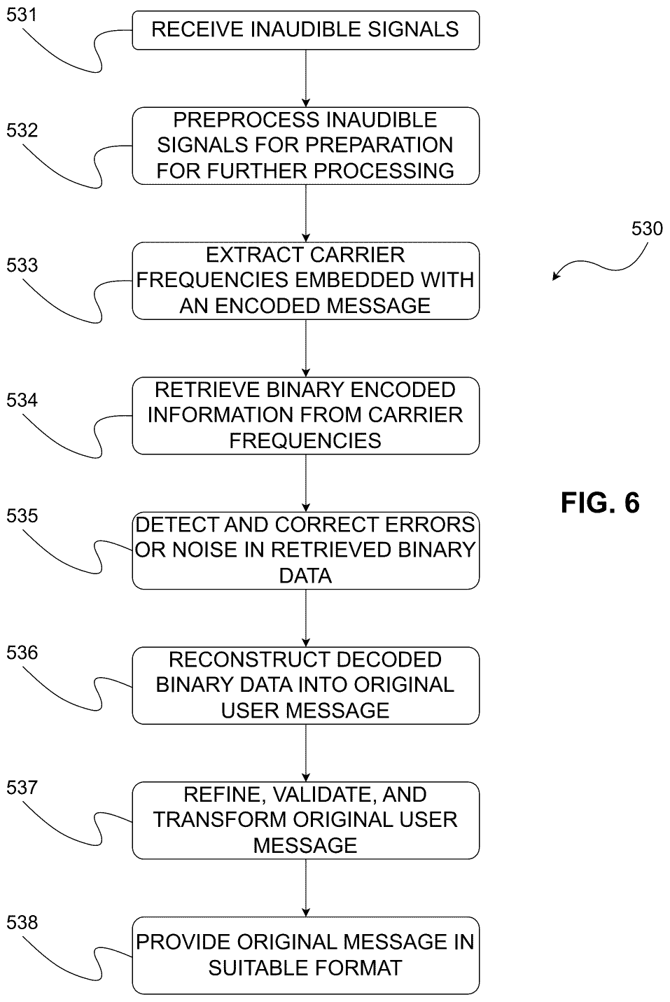

FIG. 6 is an example of a method of decoding an inaudible signal audio track containing a user's message. This method demonstrates the process of decoding and converting an inaudible signal audio track containing a user's message or data back into its original or communicable format, which complements the encoding process described in FIG. 2. The flowchart provides a comprehensive breakdown of the various steps involved, building upon the foundation laid out in FIG. 5, particularly step 530. The decoding method outlined in FIG. 6 provides a systematic approach for retrieving encoded information within detected inaudible signals. Although various steps of method 530 are described below and depicted in FIG. 6, the steps need not necessarily all be performed, and in some cases may be performed in a different order than the order shown. Moreover, the steps presented in this flowchart may be subject to variations and optimizations depending on the specific implementation.

At step 531, the decoding process begins by receiving the inaudible signals, which may be in the form of an audio file or any other suitable format containing the encoded information. The signals are acquired using a receiving device capable of capturing and processing the inaudible signals. Next, at step 532, the received inaudible signals are subjected to preprocessing operations to enhance their quality and prepare them for further analysis. This may involve techniques such as noise reduction, signal amplification, and filtering to eliminate unwanted artifacts and ensure optimal signal integrity.

Moving to step 533, the preprocessed inaudible signals are then subjected to a demodulation process to extract the carrier frequencies embedded with the encoded message. This step involves identifying and separating the distinct carrier frequencies used during the encoding process. In some embodiments, this encompasses accessing a data profile which has been previously defined during the encoding process. This data profile may encompass encoding information including, but not limited to, the number of message blocks, duration of each message block, pause period between message blocks, number of frequencies for message encoding, spacing between successive frequencies, and lowest frequency used. This data profile may be accessed on to retrieve encoding information for every encoded message allowing for efficient detection and accurate decoding by a receiving device. In further embodiments, the data profile along with other encoding information is accessed from a log table. Those skilled in the art will appreciate that different profiles or configurations can be established to adapt to specific use cases.

Once the carrier frequencies are isolated, at step 534, the demodulated signals are further processed to retrieve the binary-encoded information. The decoding process involves analyzing the signal amplitudes and durations at each carrier frequency to determine the corresponding bits within the message.

In certain embodiments, error detection and correction techniques, such as parity bits, can be employed at step 535 to ensure the accuracy of the decoded data. Parity bits can be used to verify the integrity of the message and detect and correct any potential errors or noise-induced corruption that may have occurred during transmission.

At step 536, the decoded binary information is reconstructed into the original user message or data. This involves reassembling the binary bits in the correct order and format to restore the intended message. In some embodiments, additional post-processing steps may be employed at step 537 to further refine the decoded information. These steps may include error checking and correction mechanisms, data validation, and any necessary transformations or conversions to adapt the data for its intended application.

Finally, at step 538, the decoded user message or data is made available for further processing, analysis, or utilization according to the specific requirements and objectives of the system or application.

The method described in FIG. 6 provides a systematic and structured approach to decode inaudible signals, extracting the encoded information with accuracy and reliability. By following the outlined steps, the system enables the seamless retrieval of user messages or data embedded within inaudible signals, facilitating efficient communication through audio channels. It should be noted that variations and optimizations to the described method are possible and can be implemented based on specific use cases and technical considerations.

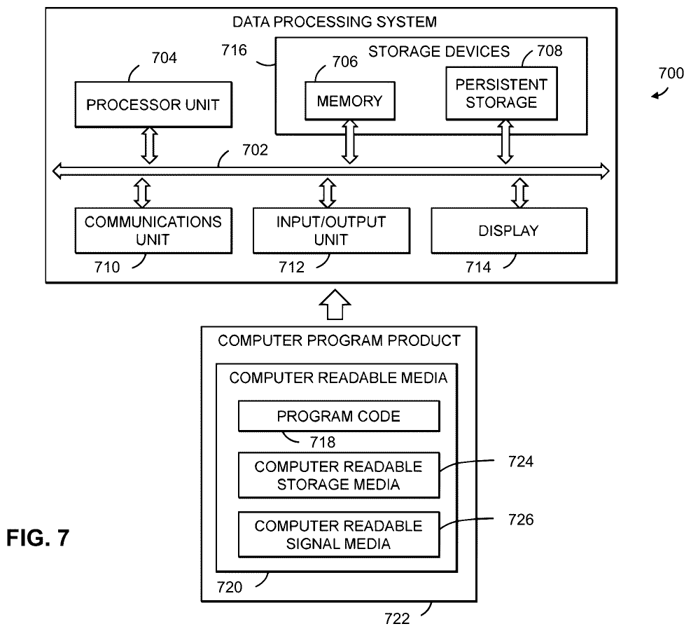

FIG. 7 shows, in accordance with aspects of the present disclosure, an example describing a data processing system 700. In this example, data processing system 700 is an illustrative data processing system suitable for implementing aspects of methods and systems of data communication over inaudible signals. More specifically, in some examples, devices that are embodiments of data processing systems, e.g., smartphones, tablets, personal computers may be used by one or more users such as retailers, customers, advertisers, consumers, patients, healthcare providers, etc. Further, devices that are embodiments of data processing systems, e.g., smartphones, tablets, personal computers, may be used as one or more server(s) in encoding, decoding, and communicating inaudible signals with one or more mobile communication devices.

In this illustrative example, data processing system 700 includes communications framework 702. Communications framework 702 provides communications between processor unit 704, memory 706, persistent storage 708, communications unit 710, input/output (I/O) unit 712, and display 714. Memory 706, persistent storage 708, communications unit 710, input/output (I/O) unit 712, and display 714 are examples of resources accessible by processor unit 704 via communications framework 702.

Processor unit 704 serves to run instructions that may be loaded into memory 706. Processor unit 704 may be a number of processors, a multi-processor core, or some other type of processor, depending on the particular implementation. Further, processor unit 704 may be implemented using a number of heterogeneous processor systems in which a main processor is present with secondary processors on a single chip. As another illustrative example, processor unit 704 may be a symmetric multi-processor system containing multiple processors of the same type.

Memory 706 and persistent storage 708 are examples of storage devices 716. A storage device is any piece of hardware that is capable of storing information, such as, for example, without limitation, data, program code in functional form, and other suitable information either on a temporary basis or a permanent basis.

Storage devices 716 also may be referred to as computer-readable storage devices in these examples. Memory 706, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these examples, provides for communications with other data processing systems or devices. In these examples, communications unit 710 is a network interface card. Communications unit 710 may provide communications through the use of either or both physical and wireless communications links.

Input/output (I/O) unit 712 allows for input and output of data with other devices that may be connected to data processing system 700. For example, input/output (I/O) unit 712 may provide a connection for user input through a keyboard, a mouse, and/or some other suitable input device. Further, input/output (I/O) unit 712 may send output to a printer. Display 714 provides a mechanism to display information to a user.

Instructions for the operating system, applications, and/or programs may be located in storage devices 716, which are in communication with processor unit 704 through communications framework 702. In these illustrative examples, the instructions are in a functional form on persistent storage 708. These instructions may be loaded into memory 706 for execution by processor unit 704. The processes of the different embodiments may be performed by processor unit 704 using computer-implemented instructions, which may be located in a memory, such as memory 706.

These instructions are referred to as program instructions, program code, computer usable program code, or computer-readable program code that may be read and executed by a processor in processor unit 704. The program code in the different embodiments may be embodied on different physical or computer-readable storage media, such as memory 706 or persistent storage 708.

Program code 718 is located in a functional form on computer-readable media 720 that is selectively removable and may be loaded onto or transferred to data processing system 700 for execution by processor unit 704. Program code 718 and computer-readable media 720 form computer program product 722 in these examples. In one example, computer-readable media 720 may be computer-readable storage media 724 or computer-readable signal media 726.

Computer-readable storage media 724 may include, for example, an optical or magnetic disk that is inserted or placed into a drive or other device that is part of persistent storage 708 for transfer onto a storage device, such as a hard drive, that is part of persistent storage 708. Computer-readable storage media 724 also may take the form of a persistent storage, such as a hard drive, a thumb drive, or a flash memory, that is connected to data processing system 700. In some instances, computer-readable storage media 724 may not be removable from data processing system 700.

In these examples, computer-readable storage media 724 is a physical or tangible storage device used to store program code 718 rather than a medium that propagates or transmits program code 718. Computer-readable storage media 724 is also referred to as a computer-readable tangible storage device or a computer-readable physical storage device. In other words, computer-readable storage media 724 is non-transitory.

Alternatively, program code 718 may be transferred to data processing system 700 using computer-readable signal media 726. Computer-readable signal media 726 may be, for example, a propagated data signal containing program code 718. For example, computer-readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 718 may be downloaded over a network to persistent storage 708 from another device or data processing system through computer-readable signal media 726 for use within data processing system 700. For instance, program code stored in a computer-readable storage medium in a server data processing system may be downloaded over a network from the server to data processing system 700. The data processing system providing program code 718 may be a server computer, a client computer, or some other device capable of storing and transmitting program code 718.

The different components illustrated for data processing system 700 are not meant to provide architectural limitations to the manner in which different embodiments may be implemented. The different illustrative embodiments may be implemented in a data processing system including components in addition to and/or in place of those illustrated for data processing system 700. Other components shown in FIG. 7 can be varied from the illustrative examples shown. The different embodiments may be implemented using any hardware device or system capable of running program code. As one example, data processing system 700 may include organic components integrated with inorganic components and/or may be comprised entirely of organic components excluding a human being. For example, a storage device may be comprised of an organic semiconductor.

In another illustrative example, processor unit 704 may take the form of a hardware unit that has circuits that are manufactured or configured for a particular use. This type of hardware may perform operations without needing program code to be loaded into a memory from a storage device to be configured to perform the operations.

For example, when processor unit 704 takes the form of a hardware unit, processor unit 704 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 718 may be omitted, because the processes for the different embodiments are implemented in a hardware unit.

In still another illustrative example, processor unit 704 may be implemented using a combination of processors found in computers and hardware units. Processor unit 704 may have a number of hardware units and a number of processors that are configured to run program code 718. With this depicted example, some of the processes may be implemented in the number of hardware units, while other processes may be implemented in the number of processors.

In another example, a bus system may be used to implement communications framework 702 and may be comprised of one or more buses, such as a system bus or an input/output (I/O) bus. Of course, the bus system may be implemented using any suitable type of architecture that provides for a transfer of data between different components or devices attached to the bus system.

Additionally, communications unit 710 may include a number of devices that transmit data, receive data, or both transmit and receive data. Communications unit 710 may be, for example, a modem or a network adapter, two network adapters, or some combination thereof. Further, a memory may be, for example, memory 706, or a cache, such as that found in an interface and memory controller hub that may be present in communications framework 702.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

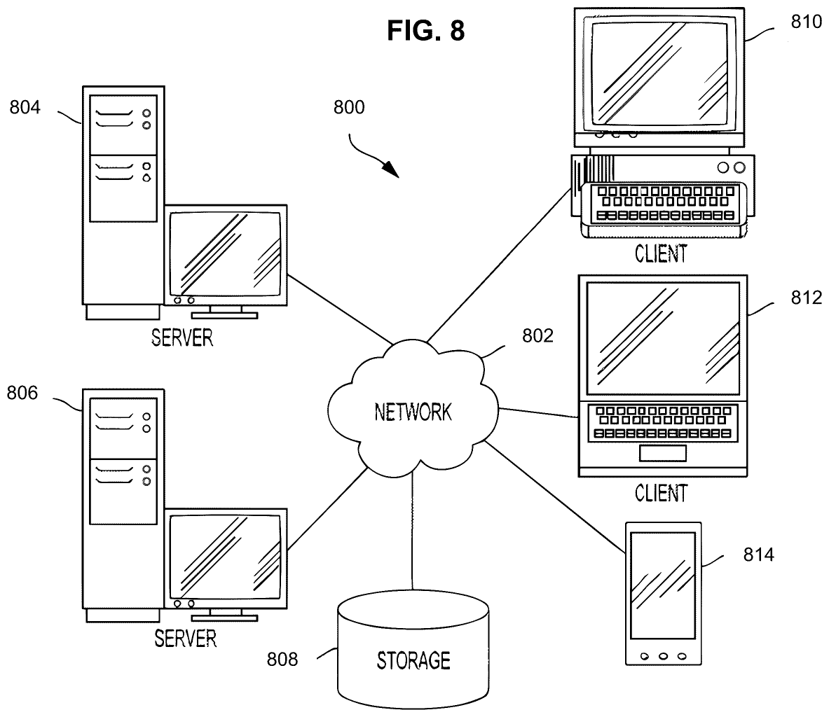

FIG. 8 shows an example describing a general network data processing system 800, interchangeably termed a network, a computer network, a network system, or a distributed network, aspects of which may be included in one or more illustrative embodiments of methods and systems of data communication over inaudible signals. For example, one or more mobile computing devices or data processing devices may communicate with one another or with one or more servers(s) through the network. It should be appreciated that FIG. 8 is provided as an illustration of one implementation and is not intended to imply any limitation with regard to environments in which different embodiments may be implemented. Many modifications to the depicted environment may be made.

Network data processing system 800 is a network of computers, each of which is an example of data processing system 700, and other components. Network data processing system 800 may include network 802, which is a medium configured to provide communications links between various devices and computers connected together within network data processing system 800. Network 802 may include connections such as wired or wireless communication links, fiber optic cables, and/or any other suitable medium for transmitting and/or communicating data between network devices, or any combination thereof.

In the depicted example, a first network device 804 and a second network device 806 connect to network 802, as does an electronic storage device 808. Network devices 804 and 806 are each examples of data processing system 700, described above. In the depicted example, devices 804 and 806 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as a client computer 810, a client laptop or tablet 812, and/or a client smart device 814, may connect to network 802. Each of these devices is an example of data processing system 700, described above regarding FIG. 7. Client electronic devices 810, 812, and 814 may include, for example, one or more personal computers, network computers, and/or mobile computing devices such as personal digital assistants (PDAs), smart phones, handheld gaming devices, wearable devices, and/or tablet computers, and the like. In the depicted example, server 804 provides information, such as boot files, operating system images, and applications to one or more of client electronic devices 810, 812, and 814. Client electronic devices 810, 812, and 814 may be referred to as “clients” with respect to a server such as server computer 804. Network data processing system 800 may include more or fewer servers and clients or no servers or clients, as well as other devices not shown.

Client smartdevice 814 may include any suitable portable electronic device capable of wireless communications and execution of software, such as a smartphone or a tablet. Generally speaking, the term “smartphone” may describe any suitable portable electronic device having more advanced computing ability and network connectivity than a typical mobile phone. In addition to making phone calls (e.g., over a cellular network), smartphones may be capable of sending and receiving emails, texts, and multimedia messages, accessing the Internet, and/or functioning as a web browser. Smartdevices (e.g., smartphones) may also include features of other known electronic devices, such as a media player, personal digital assistant, digital camera, video camera, and/or global positioning system. Smartdevices (e.g., smartphones) may be capable of connecting with other smartdevices, computers, or electronic devices wirelessly, such as through near field communications (NFC), Bluetooth®, Wi-Fi, or mobile broadband networks. Wireless connectivity may be established among smartdevices, smartphones, computers, and other devices to form a mobile network where information can be exchanged.

Program code located in system 800 may be stored in or on a computer recordable storage medium, such as persistent storage 708 in FIG. 7, and may be downloaded to a data processing system or other device for use. For example, program code may be stored on a computer recordable storage medium on server computer 804 and downloaded for use to client 810 over network 802 for use on client 810.

Network data processing system 800 may be implemented as one or more of a number of different types of networks. For example, system 800 may include an intranet, a local area network (LAN), a wide area network (WAN), or a personal area network (PAN). In some examples, network data processing system 800 includes the Internet, with network 802 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. FIG. 8 is intended as an example, and not as an architectural limitation for any illustrative embodiments.

Put differently, disclosed here is a method for transmitting data comprising: receiving user input as one or more message blocks; converting the one or more message blocks into converted messages blocks by: translating each one of the one or more message blocks into binary data each having one or more bits; converting the binary data of the one or more message blocks into one or more digital signals; and transforming the one or more digital signals into one or more sequential time blocks each of the time blocks having a predetermined duration; defining one or more frequency bands encompassing a plurality of carrier frequencies with each carrier frequency having a predetermined spacing from one or more adjacent carrier frequencies of the plurality of carrier frequencies wherein the one or more frequency bands are in a range inaudible to humans; modulating each one of the plurality of carrier frequencies with the one or more converted message blocks by varying each one of the plurality of frequencies' amplitude phase or frequency; defining a structured message format having a start block the one or more converted message blocks and an end block wherein each of the start block and the end block is composed of unique sequences of the carrier frequencies; generating an audio track incorporating the structured message modulated onto inaudible signals; and transmitting the audio track.

The method involves receiving user input as message blocks which are then translated into binary data. This binary data is converted into digital signals that are sequentially organized into time blocks. Each block represents a segment of the message, allowing for structured and efficient data handling. Frequency bands in an inaudible range are defined to ensure the transmitted signals are imperceptible to humans while providing a robust medium for data transmission. These frequencies are carefully spaced to avoid interference and allow for clear signal modulation. The method may employ various modulation techniques, such as amplitude modulation (AM), phase modulation (PM), or frequency modulation (FM), to encode the binary data onto the carrier frequencies. The structured message format with start and end blocks ensures that the message is clearly delineated and can be accurately decoded at the receiving end. This format helps in synchronizing the transmitter and receiver, reducing errors during data transmission. Finally, an audio track is generated with the modulated signals and transmitted, effectively embedding the data within an inaudible audio spectrum.

The process of mapping data involves converting user input into binary data and then modulating this binary data onto carrier frequencies. As described above, user input is first received as message blocks, each of which is translated into binary data, with each block containing one or more bits. This binary data forms the basis for subsequent encoding and modulation steps.

The binary data from the message blocks is then encoded onto carrier frequencies. Each bit of the binary data is mapped to a specific carrier frequency and modulated accordingly. This is done using techniques such as Amplitude Shift Keying (ASK), Frequency-Shift Keying (FSK), or Phase-Shift Keying (PSK), where a logical “1” might be represented by a high amplitude at a certain frequency for a specific duration, and a logical “0” might be represented by a low or zero amplitude at the same frequency for the same duration.

The message is structured in two dimensions: temporal (time) and spectral (frequency). Along the temporal dimension, the message consists of consecutive blocks, starting with a start block, followed by message blocks, and ending with an end block. Along the spectral dimension, each message block spans multiple carrier frequencies, which are equally spaced within a predefined frequency band. These frequencies are chosen to be in an inaudible range to humans. The start and end blocks have unique sequences of carrier frequencies to denote the beginning and end of the message, which helps in synchronizing the transmission and reception processes.

For example, if the binary data to be transmitted is “01010011 01101111” and there are eight carrier frequencies (F1, F2, . . . , F8), each message block will encode one bit at each carrier frequency. The first bit “0” might be represented by a low amplitude at frequency F1 for the first half of the block duration, while the second bit “1” might be represented by a high amplitude at frequency F2 for the first half of the block duration.

Further, the method comprises defining a data profile based on the converted message blocks wherein the data profile includes information about the number of frequencies used for encoding the one or more message blocks the predetermined spacing between the carrier frequencies and the duration of each one of the one or more message blocks. The data profile acts as a blueprint for both the encoding and decoding processes, ensuring consistency and accuracy. It includes parameters such as the number of carrier frequencies used, their specific spacing, and the duration of each time block. This information is useful for the receiving device to accurately reconstruct the original message. By standardizing these parameters, the system can adapt to various environmental conditions and maintain robust communication.

Embedding the audio track into existing audio content involves several processes. This includes modulating the inaudible signals to match the amplitude and phase characteristics of the existing audio content. This ensures that the embedded signals blend seamlessly without introducing noticeable artifacts. The system dynamically adjusts embedding parameters to minimize any potential interference with the original audio content. Techniques such as frequency masking are utilized to hide the inaudible signals within the natural gaps of the frequency spectrum, ensuring they remain undetectable by human ears while still being effectively transmitted.

The modulation of each carrier frequency is performed using advanced shift keying techniques such as Amplitude Shift Keying (ASK), frequency-shift keying (FSK), or phase-shift keying (PSK). These techniques allow precise control over the signal parameters, enhancing the reliability and clarity of the transmitted data. The method may also include adaptively selecting the polarity of carrier frequencies based on real-time environmental noise conditions. By analyzing the noise levels, the system dynamically allocates bits to the carrier frequencies with the best signal-to-noise ratios, optimizing transmission quality and reducing errors.

The inaudible signals used in this method are typically ultrasonic tones, chosen because they are outside the human hearing range and can carry data without being intrusive. The method may also include accessing a library of predefined inaudible signals. These signals are selected based on predefined criteria such as signal clarity, transmission distance, and environmental compatibility. This library approach ensures that the system can quickly adapt to different use cases and environments by selecting the most appropriate signals.

The modulation of carrier frequencies with the converted message blocks is performed in parallel across multiple carrier frequencies. This parallel processing increases the data transmission rate and efficiency, allowing for more complex messages to be transmitted quickly and accurately. The predefined frequency bands are carefully selected, typically from frequencies above 16000 Hz and below 300 Hz, to ensure that the signals remain inaudible to humans while providing a broad range for modulation. This selection ensures minimal interference with other audio content and maximizes the data carrying capacity.

In a method for receiving data, the steps include capturing audio data using, for example, a receiving device equipped with a microphone or similar audio capture component. The captured audio data is stored in a circular array data structure, which allows for continuous and efficient processing. This structure ensures that the system can handle real-time data streams without interruptions. The circular array is analyzed for predefined frequency bands encompassing a plurality of carrier frequencies. These frequencies are identified based on the data profile defined during encoding. The structured message format is recognized by detecting the unique sequences of the carrier frequencies in the start and end blocks. This format ensures that the beginning and end of the message are clearly identified, facilitating accurate decoding.

Detecting the encoded messages involves applying a Fourier Transform to convert the frequency domain data into binary data. This mathematical transformation allows the system to analyze the frequency components of the received signals and extract the encoded information. Each identified frequency component is mapped to a corresponding binary value, reconstructing the original message. This mapping may be based on the modulation parameters defined in the data profile. The system also includes error detection and correction mechanisms to ensure the integrity of the decoded data. Techniques such as parity checks or more advanced error correction codes are employed to identify and correct any errors that may have occurred during transmission. This step is helpful for maintaining the reliability and accuracy of the communication system.

The decoded user input is then decrypted if necessary, restoring the original message. This decryption process ensures that any security measures applied during encoding are reversed, providing the user with the intended message. The final step involves displaying the user input to a user through an appropriate interface, ensuring that the information is presented in a clear and accessible manner.

Obtaining a predefined data profile for the captured audio data involves retrieving encoding parameters that were used during the transmission. This profile includes details about the number of frequencies used, their spacing, the duration of message blocks, and other relevant parameters. By using this profile, the system can accurately decode the received signals, ensuring consistency and reliability.

Detection of encoded messages involves comparing the extracted features from the audio data with the predefined data profiles. This comparison ensures that the received signals match the expected patterns, allowing for accurate identification and decoding of the messages. This step is essential for maintaining the integrity of the communication system.

Detecting and decoding multiple encoded messages simultaneously within the captured audio data involves using separate predefined data profiles for each message. The system employs a multi-channel Fourier Transform to analyze multiple frequency bands simultaneously. Signal separation algorithms are used to isolate overlapping frequency components, ensuring that each message is accurately decoded. This approach allows for efficient processing of multiple simultaneous transmissions, enhancing the system's capacity and flexibility. Using the decoded user input to control one or more functions of a receiving device involves interpreting the decoded data as specific commands. These commands can control various functions of the receiving device, such as adjusting settings, initiating actions, or providing information to the user. This functionality enhances the interactivity and utility of the system, allowing it to perform a wide range of tasks based on the received data.

To further expand on signal separation algorithms, also known as source separation or blind source separation algorithms, the following are computational methods used to extract individual signals from a mixture of multiple signals. The first step in signal separation is preprocessing, which prepares the mixed signals for separation. This involves sampling the mixed signals and converting them into a suitable format for analysis. Preprocessing may include steps like filtering to remove noise, normalizing the signal amplitudes, and applying transformations such as the Fourier Transform to convert the signals from the time domain to the frequency domain. This transformation is particularly useful for separating signals that overlap in the time domain but have distinct frequency characteristics.

Once the signals are preprocessed, the next step is feature extraction. This involves identifying and extracting key features of the signals that can help distinguish them from one another. Features can include statistical properties like mean and variance, frequency components, or time-domain characteristics such as signal amplitude and phase. In the context of audio signals, features might also include spectral properties and temporal patterns. The goal of feature extraction is to represent the mixed signals in a way that highlights their differences, facilitating the separation process.

After extracting the relevant features, the core signal separation algorithm is applied. Several techniques are commonly used for this purpose. For example, Independent Component Analysis (ICA) may be used and it assumes that the source signals are statistically independent and aims to find a linear transformation that maximizes their independence. This is achieved by iteratively adjusting the transformation matrix to minimize mutual information or maximize non-Gaussianity. Principal Component Analysis (PCA) may also be utilized, which reduces the dimensionality of the data by finding orthogonal directions (principal components) that capture the most variance. While PCA is primarily used for data reduction, it can also aid in signal separation by highlighting dominant signal components.

Also, Non-negative Matrix Factorization (NMF) may be used to decompose the mixed signals into a set of non-negative basis signals and their corresponding weights. This method is particularly effective for separating signals that are additive and have non-negative values, such as audio spectrograms. Finally, Time-Frequency Masking involves creating masks in the time-frequency domain to isolate different components of the mixed signals. By identifying regions in the spectrogram where one signal dominates, the algorithm can suppress other signals, effectively separating them. The systems and methods disclosed herein may utilize any of these algorithms.

Once the individual signals are separated, postprocessing is often required to enhance the quality of the separated signals. This can involve applying inverse transformations to convert the signals back to the time domain, smoothing to reduce artifacts, and additional filtering to remove any residual noise or interference. Postprocessing ensures that the separated signals are as clean and accurate as possible, ready for further analysis or use. The final step in the signal separation process is validation and evaluation. This involves assessing the quality of the separated signals using objective metrics such as Signal-to-Noise Ratio (SNR), and subjective evaluations like listening tests for audio signals. Validation helps determine the effectiveness of the separation algorithm and identify any areas for improvement.

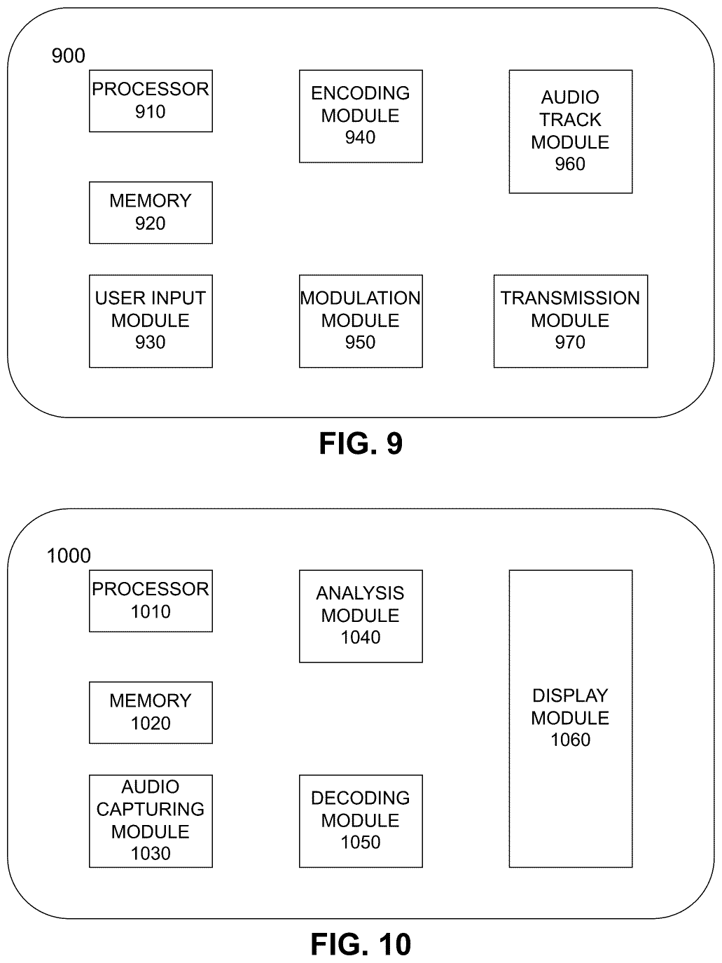

As shown in FIGS. 9 and 10, a system for transmitting and receiving data over inaudible signals comprises a transmitting device with components for receiving user input, encoding the input into binary data and digital signals, modulating the signals onto carrier frequencies, generating an audio track incorporating the modulated signals, and transmitting the audio track through an audio emitting component. The system also includes a receiving device with components for capturing audio data, detecting and decoding the inaudible signals, converting the decoded signals into user-readable data, and displaying the decoded data to the user. This comprehensive system provides a robust solution for secure and efficient data communication using inaudible signals.

The structural components of the system's various modules are designed to ensure efficient and seamless data communication over inaudible signals. Each module consists of key components that work together to achieve this goal. The modules may be connected to or be within the same processing unit that handles the core computational tasks. This processing unit executes the necessary algorithms for encoding, decoding, and data management, ensuring the accurate transformation and retrieval of information. The modules also incorporate memory storage units, which may be shared, to hold data during processing. This includes the raw input data, encoded binary data, and any intermediary results required for efficient data handling and processing.

To facilitate the transmission and reception of inaudible signals, the system may include advanced signal generators and receivers. These components generate the inaudible signals by modulating carrier frequencies and capture these signals from the environment for decoding. The audio interface components, such as speakers and microphones, embed and extract inaudible signals within standard audio content. These interfaces ensure that the inaudible data is integrated with and separated from the audible audio signals without affecting the audio quality.

A user interface provides a means for users to interact with the system. This interface includes a display unit for visual feedback and control inputs for managing system operations. Additionally, the modules are equipped with communication interfaces that enable connectivity with external devices and networks, including wireless communication capabilities like Bluetooth® and Wi-Fi, to enhance functionality and user experience.

These structural components enable the system to perform its intended functions, ensuring reliable data communication over inaudible signals across various applications.

The transmitting device 900 may include a processor 910, a memory 920, an embedding module 930 for integrating the audio track with existing audio content, an encoding module 940, a modulation module 950, an audio track generation module 970, a transmission module 970. This ensures that the embedded signals blend seamlessly with the original content, preserving audio quality while transmitting the data. The device may optionally include an embedding module 980, and a data profile definition module 990 for managing the encoding parameters, ensuring consistency and accuracy in the data transmission process.

The receiving device 1000 may utilizes the predefined data profile to enhance detection and decoding accuracy. By accessing the data profile, the device can accurately identify and decode the received signals, ensuring that the original message is reconstructed correctly. The device may also include additional modules for processing the decoded data, such as error correction and decryption modules. Specifically, the receiving device 1000 may incorporate a processor 1010, a memory 1020, an audio capturing module 1030, an analysis module 1040, a decoding module 1050, a display module 1060, and optionally, a data profile utilization module 1070.

The transmitting device can access a library of predefined inaudible signals for modulation, selecting the most appropriate signals based on predefined criteria. This library approach ensures that the system can quickly adapt to different use cases and environments. A remote server can perform encoding and modulation tasks, sending the generated audio track back to the transmitting device for emission. Similarly, the receiving device can send captured audio data to the server for decoding and receive the processed data for display. This distributed approach leverages server capabilities for efficient data processing, enhancing the system's flexibility and scalability.

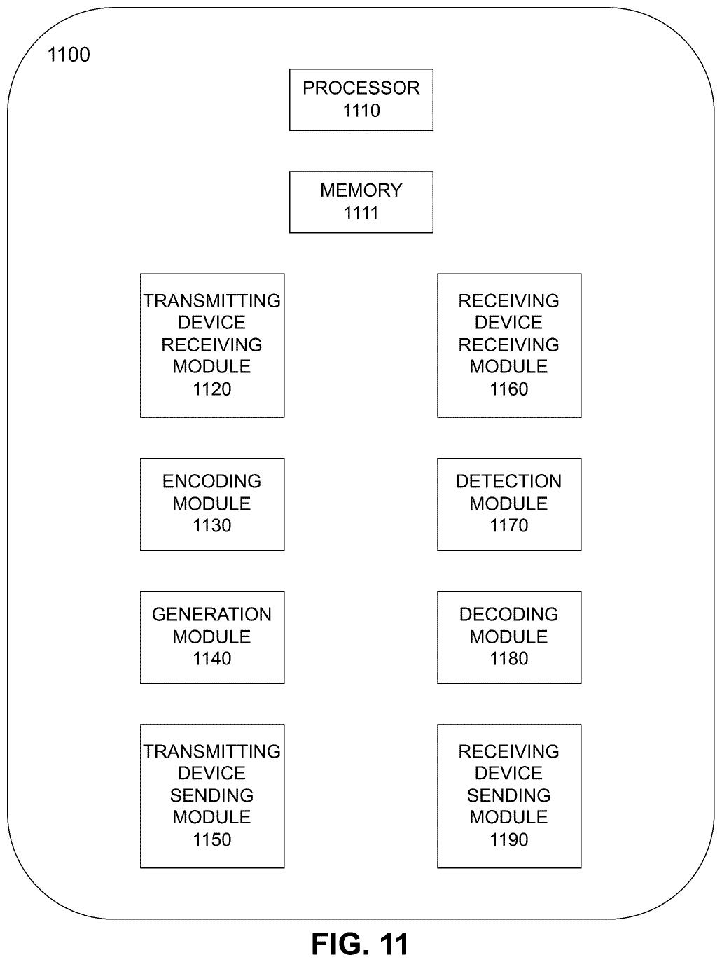

As shown in FIG. 11, the server 1100 may incorporate a processor 1110, a memory 1111, a transmitting device receiving module 1020, an encoding module 1030, a generation module 1140, a transmitting device sending module 1150, a receiving device receiving module 1060, a detection module 1170, a decoding module 1080, a receiving device sending module 1190. Any additional modules may be incorporated in the server 1100, such as modules present the transmitting device 900 and/or the receiving device 1000.

The present disclosure encompasses novel methods and systems that revolutionize users' engagement and interaction within their surroundings, overcoming the limitations associated with conventional interaction techniques heavily reliant on visual or tactile input. Various innovative approaches are introduced in this disclosure, enabling seamless access to a wide range of real-time interactive features by harnessing inaudible signals embedded in audio channels. Additionally, alternative techniques such as global positioning system (GPS)-based geofencing, quick response (QR) codes, barcodes, machine-readable images, and motion detection are utilized to achieve similar access to these features. These techniques prove particularly valuable in situations where inaudible signals are not feasible, for example, when determining user presence by arriving, leaving, or having been at a specific location, being within specific geographic zones, or engaging in a transaction.

In essence, the patented methods and systems address inefficiencies and minimize user input requirements by leveraging audio, visual, and motion triggers to deliver pertinent information and media-rich context-aware content directly to users. Consequently, the need for extensive searching and filtering is eliminated, streamlining the information retrieval process and significantly enhancing efficiency and user experience across diverse contexts.

The present disclosure, as described herein, encompasses a multitude of innovative features and functionalities that extend beyond the methods and systems for data communication over inaudible signals. For further details on the methods and systems described herein, additional information can be found in the accompanying appendix. This appendix further reveals an array of supplementary embodiments, variations, and alternative implementations, all crafted to enhance the overall utility, efficiency, and user experience of the invention. With its comprehensive nature, the appendix serves as a valuable resource, enabling future readers, researchers, and patent examiners to fully comprehend the breadth and depth of this invention.

The different embodiments of the data communication over inaudible signals described herein provide several advantages over known solutions for data transmission and communication as well as interfacing user an immersive and context-aware user interface. For example, illustrative embodiments described herein allow for seamless and, at times, hands free transmission of information without disturbing the audible audio experience. Additionally, and among other benefits, illustrative embodiments described herein allow for robust and reliable communication in noisy environments where audible signals may be compromised. Moreover, and among other benefits, illustrative embodiments herein allow for seamless integration with existing audio systems and playback devices. No known system or device can perform these functions. Thus, the illustrative embodiments described herein are particularly useful for efficient, secure, hassle free, and cost-effective data transmission. However, not all embodiments described herein provide the same advantages or the same degree of advantage.

It will be appreciated that the invention is not restricted to the particular embodiment that has been described, and that variations may be made therein without departing from the scope of the invention as defined in the appending claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method for transmitting data, comprising:
a. receiving user input as one or more message blocks;
b. converting the one or more message blocks into binary data resulting in one or more converted message blocks;
c. modulating each of the one or more converted message blocks onto one or more carrier frequencies producing one or more modulated messages, wherein the one or more carrier frequencies are within one or more predefined frequency bands, wherein each carrier frequency having a predetermined spacing from one or more adjacent carrier frequencies, wherein the one or more predefined frequency bands are in a range inaudible to humans;
d. generating an audio track incorporating the one or more modulated messages; and
e. transmitting the audio track.

2. The method of claim 1, further comprising creating one or more data profiles based on the one or more modulated messages, wherein each of the one or more data profiles includes information about the number of frequencies used for encoding the one or more modulated messages, the predetermined spacing between the carrier frequencies, and the duration of each one of the one or more modulated messages.

3. The method of claim 1, further comprising embedding the audio track into existing audio content, wherein the embedding process includes:
a. modulating the audio track to match the amplitude and phase characteristics of the existing audio content;
b. dynamically adjusting parameters of the embedding process; and
c. utilizing frequency masking techniques to hide the audio track within gaps in the frequency spectrum of the existing audio content.

4. The method of claim 1, wherein the modulation of each of the one or more converted message blocks is performed via shift keying techniques.

5. The method of claim 1, further comprising:
a. adaptively selecting polarity of one or more carrier frequencies based on environmental noise conditions; and
b. dynamically allocating one or more bits of the one or more converted message blocks to the one or more carrier frequencies based on respective signal-to-noise ratios.

6. The method of claim 1, wherein the audio track comprises ultrasonic tones.

7. The method of claim 1, further comprising:
a. accessing a library of pre-existing inaudible signals; and
b. selecting one or more of the pre-existing inaudible signals from the library for modulating the one or more converted message blocks based on predefined criteria.

8. The method of claim 1, wherein the modulating of each of the one or more converted message blocks onto the one or more carrier frequencies is performed in parallel across multiple carrier frequencies.

9. The method of claim 8, wherein the predefined frequency bands are selected from frequencies above 16,000 Hz and below 300 Hz.

10. A method for receiving data, comprising:
a. capturing audio data;
b. storing the captured audio data in a circular array data structure;
c. analyzing the circular array data structure for one or more predefined frequency bands encompassing a plurality of carrier frequencies with each carrier frequency having a predetermined spacing from one or more adjacent carrier frequencies, wherein the one or more predefined frequency bands are in a range inaudible to humans;
d. identifying a structured message format having a start block, one or more message blocks, and an end block, wherein the one or more message blocks contain one or more encoded messages comprising user input and are encoded in the plurality of carrier frequencies, and wherein each of the start block and the end block is composed of unique sequences of the plurality of carrier frequencies;
e. detecting the one or more encoded messages by recognizing the unique sequences of the carrier frequencies of the start block and the end block;
f. converting each of the one or more detected encoded messages from frequency domain data into binary data by:
i. applying a Fourier Transform to each one of the one or more detected encoded messages,
ii. analyzing frequency components through detection of variations in one or more of the amplitude, phase, or frequency of each of the plurality of carrier frequencies of the one or more detected encoded messages,
iii. mapping each identified frequency component to a corresponding binary value, and
iv. decrypting the binary data to retrieve the user input; and
g. displaying the user input to a user.

11. The method of claim 10, further comprising obtaining one or more predefined data profiles for the captured audio data, wherein each of the one or more predefined data profiles includes one or more information about number of frequencies used for encoding the one or more message blocks, the predetermined spacing between the carrier frequencies, or the duration of each one of the one or more message blocks.

12. The method as claimed in claim 11, wherein the detection of the one or more encoded messages involves comparing extracted features from the captured audio data with the one or more predefined data profiles.

13. The method of claim 10, further comprising detecting and decoding multiple encoded messages simultaneously within the captured audio data, wherein the method comprises:
a. obtaining separate predefined data profiles for each encoded message of the one or more encoded messages;
b. utilizing a multi-channel Fourier Transform to analyze multiple predefined frequency bands;
c. applying a signal separation algorithm to isolate overlapping frequency components;
d. mapping each isolated frequency component to its respective binary value based on the predefined data profiles; and
e. reconstructing the decrypted user inputs into separate messages.

14. The method of claim 10, further comprising using the decrypted user input to control one or more functions of a receiving device, wherein the method comprises:
a. interpreting the decrypted user input as having one or more control commands;
b. executing the control commands on the receiving device.

15. A system for transmitting and receiving data over inaudible signals, comprising:
a. a transmitting device having a processor, a memory, a user input module configured to receive user input as one or more message blocks, an encoding module configured to convert the message blocks into binary data and digital signals; a modulation module configured to modulate a plurality of carrier frequencies with the digital signals, where the carrier frequencies are inaudible to humans, an audio track generation module configured to generate an audio track incorporating the modulated signals; and a transmission module configured to transmit the audio track through an audio emitting component; and
b. a receiving device having a processor, a memory an audio capturing module configured to capture audio data, an analysis module configured to detect and decode the inaudible signals within the captured audio data; a decoding module configured to convert the decoded signals into user-readable data, and a display module configured to display the decoded data to a user.

16. The system of claim 15, wherein the transmitting device further comprises an embedding module configured to embed the audio track with the modulated signals into existing audio content.

17. The system of claim 15, wherein the transmitting device further comprises a data profile definition module configured to define a data profile for the encoded message blocks, including information about frequency bands, the carrier frequencies, and modulation parameters.

18. The system of claim 17, wherein the receiving device further comprises a data profile utilization module configured to retrieve the data profile defined by the transmitting device and use it to detect and decode the inaudible signals within the captured audio data.

19. The system of claim 15, wherein the transmitting device further comprises a library of predefined inaudible signals, and the modulation module is configured to select and use these predefined signals for encoding the message blocks.

20. The system of claim 15, further comprising a remote server having:
a. a processor;
b. a memory;
c. a transmitting device receiving module to receive the user input from the transmitting device, an encoding module to perform the encoding of the message blocks into binary data and digital signals, a modulation module to modulate the carrier frequencies, a generation module to generation the audio track, and a transmitting device sending module to transmit the audio track to the transmitting device for transmission through the audio emitting component;
d. a receiving device receiving module to receive the captured audio data from the receiving device, a detection module to detect and decode the inaudible signals within the captured audio data, a decoding module to convert the decoded signals into user-readable data, and a receiving device sending module to send the user-readable data back to the receiving device.
